(19) United States
(12) Patent Application Publication
(10) Pub. No.: US 2025/0367796 A1
(43) Pub. Date: Dec. 4, 2025

(54) FASTENER DRIVER

(71) Applicant: BLACK & DECKER INC., New Britain, CT (US)

(72) Inventors: Anthony BOURRET, Millersville, MD (US); Aland SANTAMARINA, Woodbine, MD (US); Jiri MASER, Towson, MD (US)

(21) Appl. No.: 19/304,503

(22) Filed: Aug. 19, 2025

Related U.S. Application Data
(63) Continuation of application No. PCT/US2024/016487, filed on Feb. 20, 2024.
(60) Provisional application No. 63/447,160, filed on Feb. 21, 2023.

(51) Int. Cl. B25B 15/00

(52) U.S. Cl. CPC B25B 15/005

(57) ABSTRACT

A fastener driver comprises a hexalobular shaped head that includes a front portion, a rear portion, and a curved intermediate portion disposed between the front portion and the rear portion. Protrusions and recesses extend along a first axial length of the front portion substantially parallel to the longitudinal axis, such that at least one of the apex diameter or the root diameter remain substantially constant along the first axial length. The protrusions and recesses extend along a second axial length of the rear portion and taper away from the longitudinal axis as they extend longitudinally toward the first end, wherein at least one of the apex diameter or the root diameter increase linearly toward the first end along the second axial length of the second portion. The protrusions and the recesses curve away from the longitudinal axis from the front portion to the rear portion in a concave manner.

### RELATED APPLICATION

The present patent application claims priority, under 35 U.S.C. § 120 to PCT Application No. PCT/US2024/016487, filed Feb. 20, 2024, titled “Fastener Driver,” which claims priority under 35 U.S.C. § 119 (e) and PCT Article 8, to U.S. Provisional Patent Application No. 63/447,160, filed Feb. 21, 2023, titled “Fastener Driver,” each of which is incorporated by reference in its entirety.

### FIELD

The present patent application relates to fastener drivers for driving star fasteners.

### BACKGROUND

A fastener driver is generally used to apply torque to loosen or tighten fasteners, e.g., fasteners having a head with a star-shaped recess with a hexalobular pattern, including fasteners sold under the TORX® brand (referred to herein as “star fasteners” or “TORX fasteners.” These fasteners are sold in various sizes, which may be designated by the letter T followed by a numerical designation, with larger numbers have larger star-shaped recesses (e.g., T15, T20, T25, etc.).

One type of the fastener driver for driving star fasteners is disclosed in U.S. Pat. No.: 3,584,667 (“the '667 Patent”). The driving head of this fastener driver comprises a star shaped pattern with hexalobular recesses and protrusions that engage with corresponding hexalobular protrusions and recesses in an opening in a top of a star fastener. The hexalobular head of the fastener driver of the '667 Patent is generally straight and not tapered, at least along the portion that engages the star fastener. The fastener driver of the '667 Patent may have an undesirable amount of wobble relative to the star fastener.

Another type of fastener driver is disclosed in U.S. Pat. No.: 4,269,246 (“the '246 Patent”). The driving head of this fastener driver comprises a star shaped pattern with a hexalobular recesses and protrusions that engage with corresponding hexalobular protrusions and recesses in an opening in a top of a star fastener. The hexalobular head of the fastener driver of the '246 patent includes a tapered front end portion followed by a straight rear end portion. The fastener driver of the '246 Patent has a tendency to cam out of star fastener heads, especially under high torque loads.

Various improvements to the prior fastener driver designs are desired.

### SUMMARY

The present patent application provides improvements in the fastener drivers.

One aspect of the present patent application provides a fastener driver that is configured to be rotated to drive a fastener is provided. The fastener driver comprises a body including a longitudinal axis, a first end for being rotated by a rotational input, and an opposing second end for engaging with and driving the fastener. The second end of the body includes a hexalobular shaped head, the hexalobular shaped head including alternating protrusions and recesses, the protrusions each having an apex and the recesses each having a root. The protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses comprise three opposing pairs of such recesses, with each pair having a root diameter that is defined by a distance from the root of one of the recesses to the root of the opposing one of the recesses, wherein such distance is measured in a plane perpendicular to the longitudinal axis, the protrusions and recesses of the hexalobular shaped head being configured to engage with corresponding recesses and protrusions of a hexalobular opening in a top of the fastener. The hexalobular shaped head further includes a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head further includes a rear portion having a second axial length. The protrusions and recesses extend along the second axial length and taper away from the longitudinal axis as they extend longitudinally toward the first end. At least one of the apex diameter or the root diameter increase linearly toward the first end along the second axial length of the rear portion. The hexalobular shaped head further includes a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

Implementations of the foregoing aspects may include one or more of the following features.

The fastener driver may further comprise a chamfered front-most end surface between the front portion and the second end of the body.

The front portion, the intermediate portion, and the rear portion may be disposed adjacent to each other in that order along the longitudinal axis of the body.

The hexalobular opening in the top of the fastener may comprise alternating protrusions and recesses. The protrusions each may have an apex and the recesses each may have a root. The hexalobular shaped head may be receivable in the hexalobular opening in the top of the fastener with the protrusions of the hexalobular shaped head engaging the recesses of the hexalobular opening and the recesses of the hexalobular shaped head engaging the protrusions of the hexalobular opening.

The protrusions of the hexalobular shaped opening may comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the hexalobular shaped opening may comprise three opposing pairs of such recesses, with each pair having an inner diameter that is defined by a distance from the root of one of the recesses to the root of the opposing one of the recesses, wherein such distance is measured in a plane perpendicular to the fastener axis.

The hexalobular shaped opening may have a top end at an outer surface of the fastener and a bottom end inside the fastener top. The protrusions and recesses of the fastener may extend along an axial length and taper inward toward the fastener axis as they extend from the top end toward the bottom end. The opening may have an opening axial length from the top end to the bottom end.

A ratio of the apex diameter of the hexalobular shaped head, at a cross-sectional plane in the rear portion at a location that corresponds to a top end of the fastener when the hexalobular shaped head is fully inserted into the hexalobular opening of the fastener, to an apex diameter of the fastener, at a cross-sectional plane at the top end of the fastener, may be between approximately 0.98 and approximately 1.01.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

The fastener may be a hexalobular fastener. When the fastener driver is fully inserted into an opening of the hexalobular fastener, an angle of wobble between the longitudinal axis of the fastener driver and a longitudinal axis of the hexalobular fastener may be less than approximately 8 degrees.

The fastener driver may be a bit configured for attachment to a power tool and configured to be driven by the power tool.

The head may be configured to drive a size T20 fastener, the first axial length, the second axial length, and the third axial length may be approximately 0.29 mm, approximately 0.60 mm, and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T20 fastener, an axial length of the chamfered front-most end surface may be approximately 0.21 mm.

The head may be configured to drive a size T25 fastener, the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T25 fastener, an axial length of the chamfered front-most end surface may be approximately 0.25 mm.

The head may be configured to drive a size T27 fastener, the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T27 fastener, an axial length of the chamfered front-most end surface may be approximately 0.27 mm.

The head may be configured to drive a size T30 fastener, the first axial length, the second axial length, and the third axial length may be approximately 0.49 mm, approximately 1.10 mm and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T30 fastener, an axial length of the chamfered front-most end surface may be approximately 0.31 mm.

The head may be configured to drive a size T40 fastener, the first axial length, the second axial length, and the third axial length are approximately 0.83 mm, approximately 1.40 mm and approximately 0.82 mm, respectively.

The head may be configured to drive a size T40 fastener, the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The head may be configured to drive a size T40 fastener, an axial length of the chamfered front-most end surface may be approximately 0.37 mm.

Another aspect of the present patent application provides a fastener driver that is configured to be rotated to drive a fastener. The fastener driver comprises a body including a longitudinal axis, a first end for being rotated by a rotational input, and an opposing second end for engaging with and driving the fastener. The second end of the body includes a hexalobular shaped head. The hexalobular shaped head includes alternating protrusions and recesses. The protrusions each have an apex and the recesses each have a root. The protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses comprise three opposing pairs of such recesses, with each pair having a root diameter that is defined by a distance from the root of one of the recesses to the root of the opposing one of the recesses, wherein such distance is measured in a plane perpendicular to the longitudinal axis. The protrusions and recesses of the hexalobular shaped head being configured to engage with corresponding recesses and protrusions of a hexalobular opening in a top of the fastener. The hexalobular shaped head further includes a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head further includes a rear portion having a second axial length. The protrusions and recesses extend along the second axial length and taper away from the longitudinal axis as they extend longitudinally toward the first end. At least one of the apex diameter or the root diameter increase linearly toward the first end along the second axial length of the rear portion. The hexalobular opening in the top of the fastener comprises alternating protrusions and recesses. The protrusions each have an apex and the recesses each have a root. The hexalobular shaped head is receivable in the hexalobular opening in the top of the fastener with the protrusions of the head engaging the recesses of the opening and the recesses of the head engaging the protrusions of the opening. The protrusions of the opening comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the opening comprise three opposing pairs of such recesses, with each pair having an inner diameter that is defined by a distance from the root of one of the recesses to the root of the opposing one of the recesses, wherein such distance is measured in a plane perpendicular to the fastener axis. The opening has a top end at an outer surface of the fastener and a bottom end inside the fastener top. The protrusions and recesses of the fastener extend along an axial length and taper inward toward the fastener axis as they extend from the top end toward the bottom end. The opening has an axial length from the top end to the bottom end. A ratio of the apex diameter of the hexalobular shaped head, at a cross-sectional plane in the rear portion at a location that corresponds to the top end of the fastener when the head is fully inserted into the opening, to an apex diameter of the fastener, at cross-sectional plane at the top end of the fastener, may be between approximately 0.98 and approximately 1.01.

Implementations of the foregoing aspects may include one or more of the following features.

The second end of the body may comprise a front-most end surface being chamfered to extend away from the longitudinal axis as it extends in an axial direction toward the first end. The chamfered front-most end surface may be between the front portion and the second end of the body. The hexalobular shaped head may further include a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

The chamfered front-most end surface, the front portion, the intermediate portion, and the rear portion may be disposed adjacent to each other in that order along the longitudinal axis of the body.

The head may be configured to drive a size T20 fastener, an axial length of the chamfered front-most end surface may be approximately 0.21 millimeters, and the first axial length, the second axial length, and the third axial length may be approximately 0.29 mm, approximately 0.60 mm and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T25 fastener, an axial length of the chamfered front-most end surface may be approximately 0.25 mm; and the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T27 fastener, an axial length of the chamfered front-most end surface may be approximately 0.27 mm; and the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T30 fastener, an axial length of the chamfered front-most end surface may be approximately 0.31 mm; and wherein the first axial length, the second axial length, and the third axial length may be approximately 0.49 mm, approximately 1.10 mm, and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T40 fastener, an axial length of the chamfered front-most end surface may be approximately 0.37 mm; and the first axial length, the second axial length, and the third axial length may be approximately 0.83 mm, approximately 1.40 mm and approximately 0.82 mm, respectively.

The head may be configured to drive a size T40 fastener, the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The fastener may be a hexalobular fastener. When the fastener driver is fully inserted into an opening of the hexalobular fastener, an angle of wobble between the longitudinal axis of the fastener driver and a longitudinal axis of the hexalobular fastener may be less than approximately 8 degrees.

The fastener driver may be a bit configured for attachment to a power tool and configured to be driven by the power tool.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

Yet another aspect of the present patent application provides a fastener driver that is configured to be rotated to drive a fastener. The fastener driver comprises a body including a longitudinal axis, a first end for being rotated by a rotational input, and an opposing second end for engaging with and driving the fastener. The second end of the body includes a hexalobular shaped head, the hexalobular shaped head including alternating protrusions and recesses. The protrusions each have an apex and the recesses each have a root. The protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses comprise three opposing pairs of such recesses, with each pair having a root diameter that is defined by a distance from the root of one of the recesses to the root of the opposing one of the recesses, wherein such distance is measured in a plane perpendicular to the longitudinal axis. The protrusions and recesses of the hexalobular shaped head being configured to engage with corresponding recesses and protrusions of a hexalobular opening in a top of the fastener. The hexalobular shaped head further includes a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head further includes a rear portion having a second axial length. The protrusions and recesses extend along the second axial length and taper away from the longitudinal axis as they extend longitudinally toward the first end, wherein at least one of the apex diameter or the root diameter increase linearly toward the first end along the second axial length of the rear portion. When the fastener driver is fully inserted into the hexalobular opening of the fastener, an angle of wobble between the longitudinal axis of the fastener driver and a longitudinal axis of the fastener may be less than approximately 8 degrees.

Implementations of the foregoing aspects may include one or more of the following features.

The second end of the body may comprise a front-most end surface being chamfered to extend away from the longitudinal axis as it extends in an axial direction toward the first end. The chamfered front-most end surface may be between the front portion and the second end of the body. The hexalobular shaped head may further include a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

The chamfered front-most end surface, the front portion, the curved intermediate portion, and the rear portion may be disposed adjacent to each other in that order along the longitudinal axis of the body.

The head may be configured to drive a size T20 fastener, an axial length of the chamfered front-most end surface may be approximately 0.21 mm, and the first axial length, the second axial length, and the third axial length may be approximately 0.29, approximately 0.60 mm and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T25 fastener, an axial length of the chamfered front-most end surface may be approximately 0.25 mm; and the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T27 fastener, an axial length of the chamfered front-most end surface may be approximately 0.27 mm; and the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T30 fastener, an axial length of the chamfered front-most end surface may be approximately 0.31 mm; and the first axial length, the second axial length, and the third axial length may be approximately 0.49, approximately 1.10 mm and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T40 fastener, an axial length of the chamfered front-most end surface may be approximately 0.37 mm; and the first axial length, the second axial length, and the third axial length may be approximately 0.83 mm, approximately 1.40 mm and approximately 0.82 mm, respectively.

The head may be configured to drive a size T40 fastener, and the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The fastener driver may be a hexalobular driver that is a bit configured for attachment to a power tool and configured to be driven by the power tool.

The hexalobular opening in the top of the fastener may comprise alternating protrusions and recesses. The protrusions may each have an apex and the recesses may each have a root. The hexalobular shaped head may be receivable in the hexalobular opening in the top of the fastener with the protrusions of the hexalobular shaped head engaging the recesses of the hexalobular opening and the recesses of the hexalobular shaped head engaging the protrusions of the hexalobular opening.

The protrusions of the hexalobular shaped opening may comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the hexalobular shaped opening may comprise three opposing pairs of such recesses, with each pair having an inner diameter that is defined by a distance from the root of one of the recesses to the root of the opposing one of the recesses, wherein such distance is measured in a plane perpendicular to the fastener axis.

The hexalobular shaped opening may have a top end at an outer surface of the fastener and a bottom end inside the fastener top. The protrusions and recesses of the fastener may extend along an axial length and taper inward toward the fastener axis as they extend from the top end toward the bottom end. The opening may have an opening axial length from the top end to the bottom end.

A ratio of the apex diameter of the hexalobular shaped head, at a cross-sectional plane in the rear portion at a location that corresponds to a top end of the fastener when the hexalobular shaped head is fully inserted into the hexalobular opening of the fastener, to an apex diameter of the fastener, at a cross-sectional plane at the top end of the fastener, may be between approximately 0.98 and approximately 1.01.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

Yet another aspect of the present patent application provides a system is provided. The system may comprise a fastener driver and a fastener. The fastener driver may be configured to be rotated to drive the fastener. The fastener driver comprises a body including a longitudinal axis, a first end for being rotated by a rotational input, and an opposing second end for engaging with and driving the fastener. The second end of the body includes a hexalobular shaped head, the hexalobular shaped head including alternating protrusions and recesses. The protrusions may each have an apex and the recesses may each have a root. The protrusions may comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses may comprise three opposing pairs of such recesses, with each pair having a root diameter that is defined by a distance from the root of one of the recesses to the root of the opposing one of the recesses, wherein such distance is measured in a plane perpendicular to the longitudinal axis. The protrusions and recesses of the hexalobular shaped head being configured to engage with corresponding recesses and protrusions of a hexalobular opening in a top of the fastener. The hexalobular shaped head may further include a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head may further include a rear portion having a second axial length. The protrusions and recesses extend along the second axial length and taper away from the longitudinal axis as they extend longitudinally toward the first end, wherein at least one of the apex diameter or the root diameter increase linearly toward the first end along the second axial length of the rear portion. The hexalobular shaped head may further include a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

Implementations of the foregoing aspects may include one or more of the following features.

The system may further comprise a chamfered front-most end surface between the front portion and the second end of the body.

The front portion, the intermediate portion, and the rear portion may be disposed adjacent to each other in that order along the longitudinal axis of the body.

The hexalobular opening in the top of the fastener may comprise alternating protrusions and recesses. The protrusions each may have an apex and the recesses each may have a root. The hexalobular shaped head may be receivable in the hexalobular opening in the top of the fastener with the protrusions of the hexalobular shaped head engaging the recesses of the hexalobular opening and the recesses of the hexalobular shaped head engaging the protrusions of the hexalobular opening.

The protrusions of the hexalobular shaped opening may comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the hexalobular shaped opening may comprise three opposing pairs of such recesses, with each pair having an inner diameter that is defined by a distance from the root of one of the recesses to the root of the opposing one of the recesses, wherein such distance is measured in a plane perpendicular to the fastener axis.

The hexalobular shaped opening may have a top end at an outer surface of the fastener and a bottom end inside the fastener top. The protrusions and recesses of the fastener extend along an axial length and taper inward toward the fastener axis as they extend from the top end toward the bottom end, and wherein the opening has an opening axial length from the top end to the bottom end.

A ratio of the apex diameter of the hexalobular shaped head, at a cross-sectional plane in the rear portion at a location that corresponds to a top end of the fastener when the hexalobular shaped head is fully inserted into the hexalobular opening of the fastener, to an apex diameter of the fastener, at a cross-sectional plane at the top end of the fastener, may be between approximately 0.98 and approximately 1.01.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

The fastener may be a hexalobular fastener. When the fastener driver is fully inserted into an opening of the hexalobular fastener, an angle of wobble between the longitudinal axis of the fastener driver and a longitudinal axis of the hexalobular fastener may be less than approximately 8 degrees.

The fastener driver may be a bit configured for attachment to a power tool and configured to be driven by the power tool.

The head may be configured to drive a size T20 fastener, the first axial length, the second axial length, and the third axial length may be approximately 0.29 mm, approximately 0.60 mm, and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T20 fastener, an axial length of the chamfered front-most end surface may be approximately 0.21 mm.

The head may be configured to drive a size T25 fastener, the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T25 fastener, an axial length of the chamfered front-most end surface may be approximately 0.25 mm.

The head may be configured to drive a size T27 fastener, the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T27 fastener, an axial length of the chamfered front-most end surface may be approximately 0.27 mm.

The head may be configured to drive a size T30 fastener, the first axial length, the second axial length, and the third axial length may be approximately 0.49 mm, approximately 1.10 mm and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T30 fastener, an axial length of the chamfered front-most end surface may be approximately 0.31 mm.

The head may be configured to drive a size T40 fastener, the first axial length, the second axial length, and the third axial length may be approximately 0.83 mm, approximately 1.40 mm and approximately 0.82 mm, respectively.

The head may be configured to drive a size T40 fastener, the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The head may be configured to drive a size T40 fastener, an axial length of the chamfered front-most end surface may be approximately 0.37 mm.

Yet another aspect of the present patent application provides a system is provided. The system comprises a fastener driver and a fastener. The fastener driver is configured to be rotated to drive the fastener and the fastener driver comprising a body including a longitudinal axis, a first end for being rotated by a rotational input, and an opposing second end for engaging with and driving the fastener. The second end of the body includes a hexalobular shaped head. The hexalobular shaped head includes alternating protrusions and recesses. The protrusions may each have an apex and the recesses may each have a root. The protrusions may comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses may comprise three opposing pairs of such recesses, with each pair having a root diameter that is defined by a distance from the root of one of the recesses to the root of the opposing one of the recesses, wherein such distance is measured in a plane perpendicular to the longitudinal axis. The protrusions and recesses of the hexalobular shaped head are configured to engage with corresponding recesses and protrusions of a hexalobular opening in a top of the fastener. The hexalobular shaped head may further include a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head may further include a rear portion having a second axial length. The protrusions and recesses extend along the second axial length and taper away from the longitudinal axis as they extend longitudinally toward the first end, wherein at least one of the apex diameter or the root diameter increase linearly toward the first end along the second axial length of the rear portion. The hexalobular opening in the top of the fastener comprises alternating protrusions and recesses, the protrusions each having an apex and the recesses each having a root, and wherein the hexalobular shaped head is receivable in the hexalobular opening in the top of the fastener with the protrusions of the head engaging the recesses of the opening and the recesses of the head engaging the protrusions of the opening. The protrusions of the opening comprise may three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the opening comprise three opposing pairs of such recesses, with each pair having an inner diameter that is defined by a distance from the root of one of the recesses to the root of the opposing one of the recesses, wherein such distance is measured in a plane perpendicular to the fastener axis. The opening has a top end at an outer surface of the fastener and a bottom end inside the fastener top, wherein the protrusions and recesses of the fastener extend along an axial length and taper inward toward the fastener axis as they extend from the top end toward the bottom end, and wherein the opening has an axial length from the top end to the bottom end. A ratio of the apex diameter of the hexalobular shaped head, at a cross-sectional plane in the rear portion at a location that corresponds to the top end of the fastener when the head is fully inserted into the opening, to an apex diameter of the fastener, at cross-sectional plane at the top end of the fastener, may be between approximately 0.98 and approximately 1.01.

Implementations of the foregoing aspects may include one or more of the following features.

The second end of the body may comprise a front-most end surface being chamfered to extend away from the longitudinal axis as it extends in an axial direction toward the first end. The chamfered front-most end surface may be between the front portion and the second end of the body. The hexalobular shaped head may further include a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

The chamfered front-most end surface, the front portion, the intermediate portion, and the rear portion may be disposed adjacent to each other in that order along the longitudinal axis of the body.

The head may be configured to drive a size T20 fastener, an axial length of the chamfered front-most end surface may be approximately 0.21 millimeters, and the first axial length, the second axial length, and the third axial length may be approximately 0.29 mm, approximately 0.60 mm and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T25 fastener, an axial length of the chamfered front-most end surface may be approximately 0.25 mm; and the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T27 fastener, an axial length of the chamfered front-most end surface may be approximately 0.27 mm; and the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T30 fastener, an axial length of the chamfered front-most end surface may be approximately 0.31 mm; and wherein the first axial length, the second axial length, and the third axial length may be approximately 0.49 mm, approximately 1.10 mm, and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T40 fastener, an axial length of the chamfered front-most end surface may be approximately 0.37 mm; and the first axial length, the second axial length, and the third axial length may be approximately 0.83 mm, approximately 1.40 mm and approximately 0.82 mm, respectively.

The head may be configured to drive a size T40 fastener, the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The fastener may be a hexalobular fastener. When the fastener driver is fully inserted into an opening of the hexalobular fastener, an angle of wobble between the longitudinal axis of the fastener driver and a longitudinal axis of the hexalobular fastener is less than approximately 8 degrees.

The fastener driver may be a bit configured for attachment to a power tool and configured to be driven by the power tool.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

Yet another aspect of the present patent application provides a system is provided. The system comprises a fastener driver and a fastener. The fastener driver is configured to be rotated to drive the fastener and the fastener driver comprising a body including a longitudinal axis, a first end for being rotated by a rotational input, and an opposing second end for engaging with and driving the fastener. The second end of the body may include a hexalobular shaped head, the hexalobular shaped head including alternating protrusions and recesses. The protrusions may each haves an apex and the recesses may each have a root. The protrusions may comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis. The recesses may comprise three opposing pairs of such recesses, with each pair having a root diameter that is defined by a distance from the root of one of the recesses to the root of the opposing one of the recesses, wherein such distance is measured in a plane perpendicular to the longitudinal axis. The protrusions and recesses of the hexalobular shaped head being configured to engage with corresponding recesses and protrusions of a hexalobular opening in a top of the fastener. The hexalobular shaped head may further include a front portion having a first axial length. The protrusions and recesses extend along the first axial length substantially parallel to the longitudinal axis, such that at least one of the apex diameter or the root diameter remain substantially constant along the first axial length of the front portion. The hexalobular shaped head may further include a rear portion having a second axial length. The protrusions and recesses extend along the second axial length and taper away from the longitudinal axis as they extend longitudinally toward the first end, wherein at least one of the apex diameter or the root diameter increase linearly toward the first end along the second axial length of the rear portion. When the fastener driver is fully inserted into the hexalobular opening of the fastener, an angle of wobble between the longitudinal axis of the fastener driver and a longitudinal axis of the fastener may be less than approximately 8 degrees.

Implementations of the foregoing aspects may include one or more of the following features.

The second end of the body may comprise a front-most end surface being chamfered to extend away from the longitudinal axis as it extends in an axial direction toward the first end. The chamfered front-most end surface may be between the front portion and the second end of the body. The hexalobular shaped head may further include a curved intermediate portion disposed between the front portion and the rear portion having a third axial length. The protrusions and the recesses curve away from the longitudinal axis from the front portion to the rear portion in a concave manner, such that at least one of the apex diameter or the root diameter increase non-linearly along the third axial length of the intermediate portion.

The chamfered front-most end surface, the front portion, the curved intermediate portion, and the rear portion may be disposed adjacent to each other in that order along the longitudinal axis of the body.

The head may be configured to drive a size T20 fastener, an axial length of the chamfered front-most end surface may be approximately 0.21 mm, and the first axial length, the second axial length, and the third axial length may be approximately 0.29, approximately 0.60 mm and approximately 0.82 mm, respectively.

The head may be configured to drive a size T20 fastener, the apex diameter and the root diameter in the front portion may be approximately 3.87 mm and approximately 2.70 mm, respectively, the apex diameter and the root diameter at a front end of the rear portion may be approximately 3.91 mm and approximately 2.75 mm, respectively, and the apex diameter and the root diameter at a rear end of the rear portion may be approximately 3.97 mm and approximately 2.81 mm, respectively.

The head may be configured to drive a size T25 fastener, an axial length of the chamfered front-most end surface may be approximately 0.25 mm; and the first axial length, the second axial length, and the third axial length may be approximately 0.35 mm, approximately 0.90 mm and approximately 0.82 mm, respectively.

The head may be configured to drive a size T25 fastener, the apex diameter and the root diameter in the front portion may be approximately 4.42 mm and approximately 3.04 mm, respectively, the apex diameter and the root diameter at a front end of the rear portion may be approximately 4.46 mm and approximately 3.11 mm, respectively, and the apex diameter and the root diameter at a rear end of the rear portion may be approximately 4.54 mm and approximately 3.20 mm, respectively.

The head may be configured to drive a size T27 fastener, an axial length of the chamfered front-most end surface may be approximately 0.27 mm; and the first axial length, the second axial length, and the third axial length may be approximately 0.43 mm, approximately 1.00 mm and approximately 0.81 mm, respectively.

The head may be configured to drive a size T27 fastener, the apex diameter and the root diameter in the front portion may be approximately 5.04 mm and approximately 3.53 mm, respectively, the apex diameter and the root diameter at a front end of the rear portion may be approximately 5.08 mm and approximately 3.58 mm, respectively, and the apex diameter and the root diameter at a rear end of the rear portion may be approximately 5.18 mm and approximately 3.70 mm, respectively.

The head may be configured to drive a size T30 fastener, an axial length of the chamfered front-most end surface may be approximately 0.31 mm; and the first axial length, the second axial length, and the third axial length may be approximately 0.49, approximately 1.10 mm and approximately 0.82 mm, respectively.

The head may be configured to drive a size T30 fastener, the apex diameter and the root diameter in the front portion may be approximately 5.52 mm and approximately 3.84 mm, respectively, the apex diameter and the root diameter at a front end of the rear portion may be approximately 5.56 mm and approximately 3.89 mm, respectively, and the apex diameter and the root diameter at a rear end of the rear portion may be approximately 5.66 mm and approximately 4.00 mm, respectively.

The head may be configured to drive a size T40 fastener, an axial length of the chamfered front-most end surface may be approximately 0.37 mm; and the first axial length, the second axial length, and the third axial length may be approximately 0.83 mm, approximately 1.40 mm and approximately 0.82 mm, respectively.

The head may be configured to drive a size T40 fastener, and the apex diameter and the root diameter in the front portion may be approximately 6.63 mm and approximately 4.62 mm, respectively, the apex diameter and the root diameter at a front end of the rear portion may be approximately 6.67 mm and approximately 4.67 mm, respectively, and the apex diameter and the root diameter at a rear end of the rear portion may be approximately 6.80 mm and approximately 4.81 mm, respectively.

The fastener driver may be a hexalobular driver that is a bit configured for attachment to a power tool and configured to be driven by the power tool.

The hexalobular opening in the top of the fastener may comprise alternating protrusions and recesses. The protrusions may each have an apex and the recesses may each have a root. The hexalobular shaped head may be receivable in the hexalobular opening in the top of the fastener with the protrusions of the hexalobular shaped head engaging the recesses of the hexalobular opening and the recesses of the hexalobular shaped head engaging the protrusions of the hexalobular opening.

The protrusions of the hexalobular shaped opening may comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis. The recesses of the hexalobular shaped opening may comprise three opposing pairs of such recesses, with each pair having an inner diameter that is defined by a distance from the root of one of the recesses to the root of the opposing one of the recesses, wherein such distance is measured in a plane perpendicular to the fastener axis.

The hexalobular shaped opening may have a top end at an outer surface of the fastener and a bottom end inside the fastener top. The protrusions and recesses of the fastener extend along an axial length and taper inward toward the fastener axis as they extend from the top end toward the bottom end. The opening may have an opening axial length from the top end to the bottom end.

A ratio of the apex diameter of the hexalobular shaped head, at a cross-sectional plane in the rear portion at a location that corresponds to a top end of the fastener when the hexalobular shaped head is fully inserted into the hexalobular opening of the fastener, to an apex diameter of the fastener, at a cross-sectional plane at the top end of the fastener, may be between approximately 0.98 and approximately 1.01.

A ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, may be between approximately 0.94 and approximately 0.98.

A ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, may be between approximately 0.95 and approximately 1.03.

A ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, may be between approximately 0.92 and approximately 0.96.

Advantages may include one or more of the following. The fastener drivers may improve torque transmission to star fasteners, may have a tighter fit with less wobble, and may have reduced instances of the fastener driver camming out of the heads of star fasteners. These and other advantages and features will be apparent from the description and the drawings.

These and other aspects of the present patent application, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 shows a fastener driver according to an embodiment of the present patent application;

FIG. 2 shows a side, view of a hexalobular shaped head of the fastener driver, where various cross-sectional planes are shown along portions of the hexalobular shaped head;

FIG. 3 shows a front view of the hexalobular shaped head of the fastener driver taken along a cross-sectional plane that is perpendicular to a longitudinal axis of the fastener driver, where an apex diameter and a root diameter of the hexalobular shaped head are shown in that cross-sectional plane;

FIG. 4 shows a side, close-up view of the hexalobular shaped head of the fastener driver, where various cross-sectional planes are shown along portions of the hexalobular shaped head;

FIGS. 5-6 show a side view and a side, close-up view of the hexalobular shaped head of the fastener driver, where the head is configured to drive a star fastener, and where various cross-sectional planes are shown in FIG. 5 along portions of the hexalobular shaped head;

FIG. 7 shows a front view of the hexalobular shaped head of the fastener driver.

FIG. 8 shows a cross-sectional view, taken along a cross-sectional line/plane 1 on FIG. 4, of the hexalobular shaped head of the fastener driver, where the cross-sectional view is taken along a cross-sectional plane at a front end of a front portion of the hexalobular shaped head of the fastener driver;

FIG. 9 shows a cross-sectional view, taken along a cross-sectional line/plane 1a on FIG. 4, of the hexalobular shaped head of the fastener driver, where the cross-sectional view is taken along a cross-sectional plane at a rear end of the front portion of the hexalobular shaped head of the fastener driver or at a front end of a curved intermediate portion of the hexalobular shaped head of the fastener driver;

FIG. 10 shows a cross-sectional view, taken along a cross-sectional line/plane 1b on FIG. 4, of the hexalobular shaped head of the fastener driver, where the cross-sectional view is taken along a cross-sectional plane that is disposed somewhere in between the front end and a rear end of the intermediate portion of the hexalobular shaped head of the fastener driver;

FIG. 11 shows a cross-sectional view, taken along a cross-sectional line/plane 2 on FIG. 4, of the hexalobular shaped head of the fastener driver, where the cross-sectional view is taken along a cross-sectional plane at the rear end of the intermediate portion of the hexalobular shaped head of the fastener driver or at a front end of a rear portion of the hexalobular shaped head of the fastener driver;

FIG. 12 shows a cross-sectional view, taken along a cross-sectional line/plane 2b on FIG. 4, of the hexalobular shaped head of the fastener driver, where the cross-sectional view is taken along a cross-sectional plane that is disposed somewhere in between the front end and a rear end of the rear portion of the hexalobular shaped head of the fastener driver;

FIG. 13 shows a cross-sectional view, taken along a cross-sectional line/plane 3 on FIG. 4, of the hexalobular shaped head of the fastener driver, where the cross-sectional view is taken along a cross-sectional plane at the rear end of the rear portion of the hexalobular shaped head of the fastener driver;

FIGS. 14a-14c show a side view and two cross-sectional views of the hexalobular shaped head of the fastener driver, where the head is configured to drive a size T20 fastener, where FIG. 14b shows the cross-sectional view of the hexalobular shaped head of the fastener driver that is taken along axis A-A (i.e., after the intermediate portion) in FIG. 14a, and where FIG. 14c shows the cross-sectional view of the hexalobular shaped head of the fastener driver that is taken along axis B-B (i.e., after the rear portion) in FIG. 14a;

FIGS. 15a-15c show a side view and two cross-sectional views of the hexalobular shaped head of the fastener driver, where the head is configured to drive a size T25 fastener, where FIG. 15b shows the cross-sectional view of the hexalobular shaped head of the fastener driver that is taken along axis A-A (i.e., after the intermediate portion) in FIG. 15a, and where FIG. 15c shows the cross-sectional view of the hexalobular shaped head of the fastener driver that is taken along axis B-B (i.e., after the rear portion) in FIG. 15a;

FIGS. 16a-16c show a side view and two cross-sectional views of the hexalobular shaped head of the fastener driver, where the head is configured to drive a size T27 fastener, where FIG. 16b shows the cross-sectional view of the hexalobular shaped head of the fastener driver that is taken along axis A-A (i.e., after the intermediate portion) in FIG. 16a, and where FIG. 16c shows the cross-sectional view of the hexalobular shaped head of the fastener driver that is taken along axis B-B (i.e., after the rear portion) in FIG. 16a;

FIGS. 17a-17c show a side view and two cross-sectional views of the hexalobular shaped head of the fastener driver, where the head is configured to drive a size T30 fastener, where FIG. 17b shows the cross-sectional view of the hexalobular shaped head of the fastener driver that is taken along axis A-A (i.e., after the intermediate portion) in FIG. 17a, and where FIG. 17c shows the cross-sectional view of the hexalobular shaped head of the fastener driver that is taken along axis B-B (i.e., after the rear portion) in FIG. 17a;

FIGS. 18a-18c show a side view and two cross-sectional views of the hexalobular shaped head of the fastener driver, where the head is configured to drive a size T40 fastener, where FIG. 18b shows the cross-sectional view of the hexalobular shaped head of the fastener driver that is taken along axis A-A (i.e., after the intermediate portion) in FIG. 18a, and where FIG. 18c shows the cross-sectional view of the hexalobular shaped head of the fastener driver that is taken along axis B-B (i.e., after the rear portion) in FIG. 18a;

FIG. 19A shows a star fastener according to an embodiment of the present patent application;

FIG. 19B shows a top view of the star fastener according to an embodiment of the present patent application;

FIG. 19C shows a top perspective view of the star fastener according to an embodiment of the present patent application;

FIG. 20A shows a system that includes a fastener driver and a star fastener according to an

embodiment of the present patent application;

FIG. 20B shows a cross-section view of the system in which the fastener driver head inserted into the opening of the head of a star fastener according to an embodiment of the present patent application;

FIG. 20C shows another cross-section view of the system in which the fastener driver head inserted into the opening of the head of a star fastener according to an embodiment of the present patent application;

FIGS. 21A-21B show a fastener driver that is configured for attachment to a power tool and configured to be driven by the power tool;

FIGS. 22A-22B show a fastener driver that is configured for attachment to a hand tool and configured to be rotated by the hand tool;

FIG. 23 shows a graphical representation of a comparison of angles of wobble for star fastener drivers of the present patent application and angles of wobble for prior art fastener drivers when engaged with heads of star fasteners, where the angle of wobble is measured between a longitudinal axis of the fastener driver and a longitudinal axis of the fastener when the fastener driver is fully inserted into an opening of the fastener; and

FIG. 24 shows an exemplary inclinometer test rig that is used to measure the angle of wobble of a fastener driver.

FIG. 25 is a graph showing results of life tests of existing fastener drivers and fastener drivers of the present patent application.

### DETAILED DESCRIPTION

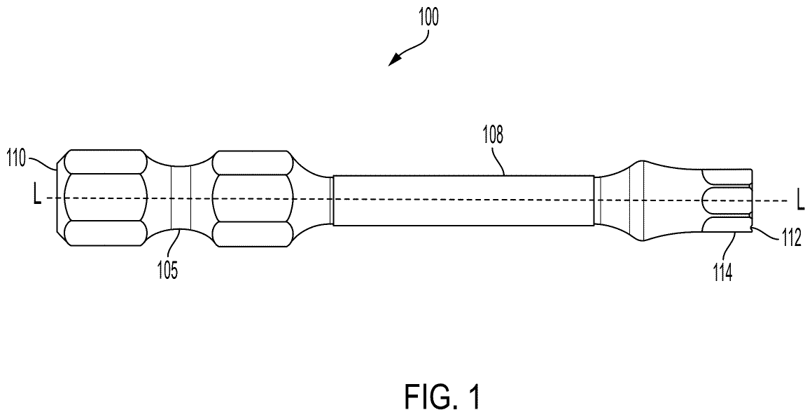

The present patent application relates to embodiments of fastener drivers that are configured to be rotated to drive star fasteners. Referring to FIG. 1, in an exemplary embodiment, a fastener driver 100 comprises a body 108 including a longitudinal axis L-L, a first end 110 for being rotated by a rotational input (e.g., from a hand tool 104 or from a power tool 106), and an opposing second end 112 for engaging with and driving the fastener 102. The body 108 is made of a metal material. The body 108 may interchangeably referred to as a shaft.

The first end 110 is configured to be mounted for rotation by a hand tool 104 or a power tool 106. That is, the first end 110 is configured to be removably attached to (e.g., a socket or an opening in) the hand tool 104 or the power tool 106. The first end 110 may interchangeably referred to as rear end or rear end portion. In one embodiment, the first end 110 has a shaft with a polygonal (e.g., hexagonal) cross section and a circumferential groove (or ball groove) 105 for mounting the body 108 for rotation by the hand tool 104 or the power tool 106.

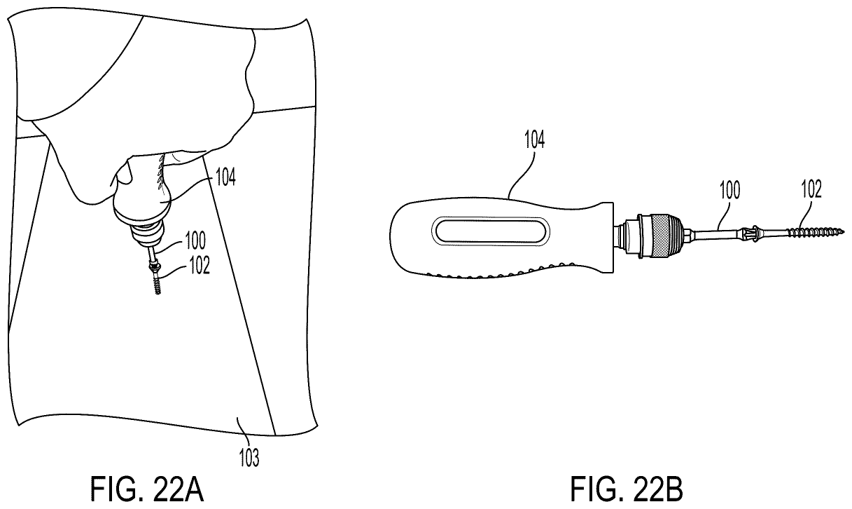

In one embodiment, as shown in FIGS. 22A-22B, the fastener driver 100 is configured to be rotated by the hand tool 104 to drive the fastener 102 into a workpiece 103. That is, the fastener driver 100 is configured for attachment to the hand tool 104. The hand tool may generally include a handle for a user to grasp (e.g., that ensures the hand tool does not slip) and a body having an opening configured to receive the first end 110 of the fastener driver 100 therein. A portion of the hand tool body may include a lock member configured to releasably engage with the circumferential groove 105 on the first end 110 of the body 108. The lock member may include one or more detent balls or pins that are positioned within a hollow, cylinder-shaped hand tool body. The one or more detent balls or pins are spring/resiliently biased into engagement with the circumferential groove 105 on the first end 110 of the body 108. The lock, in another exemplary embodiment, may include a spring biased clip that is spring/resiliently biased into engagement with the circumferential groove 105 on the first end 110 of the body 108.

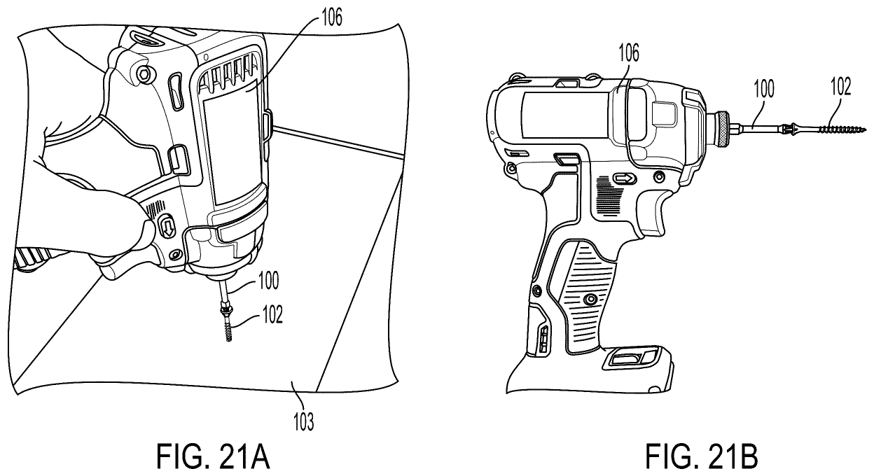

In yet another embodiment, as shown in FIGS. 21A-21B, the fastener driver 100 is configured to be driven/rotated by the power tool 106 (e.g., a drill, a drill/driver, a powered screwdriver, or an impact driver) to drive the fastener 102 into the workpiece 103. That is, the fastener driver 100 is configured for attachment to the power tool 106. Reference may be made to a variety of patents/patent publications for a more complete understanding of the conventional features of the power tool 106. One example of such patents is U.S. Pat. No.: 5,897,454 issued Apr. 27, 1999, which is hereby incorporated by reference in the present patent application in its entirety. The power tool 106 may generally include a housing having a handle and a trigger mechanism for activating the power tool 106. The housing is adapted to receive a battery pack for use as a cordless power tool. It should be understood that the power tool 106 can also be pneumatic, hydraulic and corded electrical power tool. The power tool 106 may be a portable device. The power tool 106 may include a motor and a transmission disposed in the housing and may be configured to provide a torque to an output shaft. The output shaft is proximate a front end of the housing and is coupled/connected to a tool holder for holding a power tool accessory, e.g., the fastener driver 100 of the present patent application.

The tool holder may be interchangeably referred to as an end effector, a chuck, etc. The chuck assembly or tool/bit holder is provided to connect the fastener driver 100 to the power tool 106. The output shaft of the power tool 106 is configured to rotationally drive the tool holder that is configured to receive the fastener driver 100 therein. An exemplary tool/bit holder for the power tool is disclosed in U.S. Pat. No.: 8,622,401, which is incorporated by reference in its entirety. The chuck assembly or tool/bit holder is configured to removably receive the first end 110 of the body 108 of the present patent application. The chuck assembly or tool/bit holder may include a lock member configured to engage with the circumferential groove 105 on the first end 110 of the body 108. The lock member may be similar to the lock member described in detail with respect to the hand tool 104 above.

Referring to FIG. 3, the second end 112 of the body 108 may interchangeably referred to as front end or front end portion. The second end 112 of the body 108 includes a hexalobular shaped head 114.

The hexalobular configuration generally includes six lobes. The hexalobular shaped head 114 includes alternating protrusions 116 and recesses 118. The protrusions 116 each has an apex 120. The protrusions 116 comprise three opposing pairs 116a and 116a′, 116b and 116b′, and 116c and 116c′ of such protrusions. Each pair 116a and 116a′, 116b and 116b′, and 116c and 116c′ has an apex diameter FDAD that is defined by a distance from the apex 120a, 120b, 120c of one of the protrusions 116a, 116b, 116c to the apex 120a′, 120b′, 120c′ of the opposing one of the protrusions 116a′, 116b′, 116c′. Such distance (i.e., the apex diameter FDAD) is measured in a (e.g., cross-sectional) plane perpendicular to the longitudinal axis L-L.

The recesses 118 each has a root 122. The recesses 118 comprise three opposing pairs 118a and 118a′, 118b and 118b′, and 118c and 118c′ of such recesses. Each pair 118a and 118a′, 118b and 118b′, and 118c and 118c′ has a root diameter FDRD that is defined by a distance from the root 122a, 122b, 122c of one of the recesses 118a, 118b, and 118c to the root 122a′, 122b′, 122c′ of the opposing one of the recesses 118a′, 118b′, and 118c′. Such distance (i.e., root diameter FDRD) is measured in a plane (i.e., a cross-sectional plane) perpendicular to the longitudinal axis L-L).

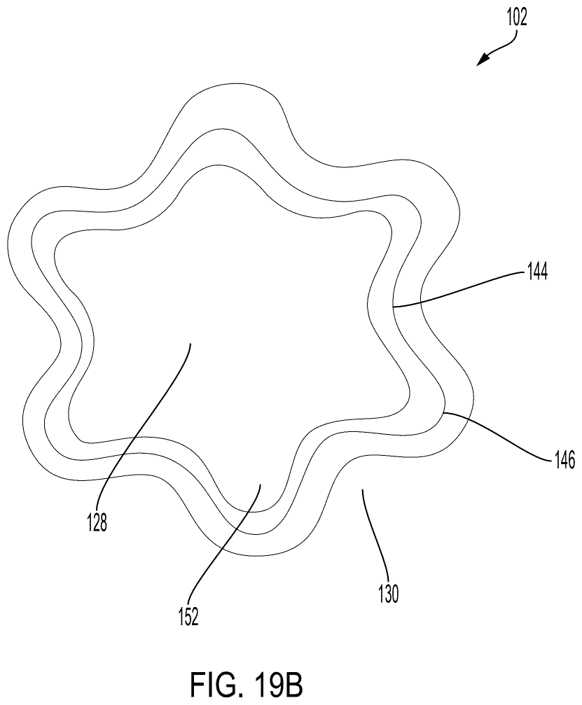

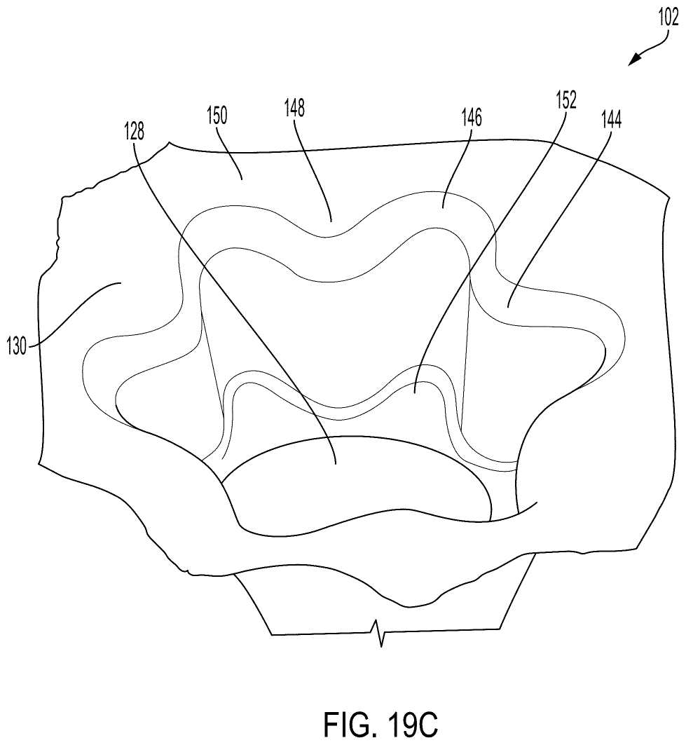

The protrusions 116 and recesses 118 of the hexalobular shaped head 114 are configured to engage with corresponding recesses 146 and protrusions 144 of a hexalobular opening 128 in a top 130 of the fastener 102 (as shown in FIGS. 19A-C). The protrusions 144 and the recesses 146 of the fastener 102 are shown and described in detail below with respect to FIGS. 19A-C.

The hexalobular shaped head 114 includes the front portion 132, the rear portion 134, and a curved intermediate portion 136. The front portion 132 may be a straight front portion 132 and the rear portion 134 may be a tapered rear portion 134.

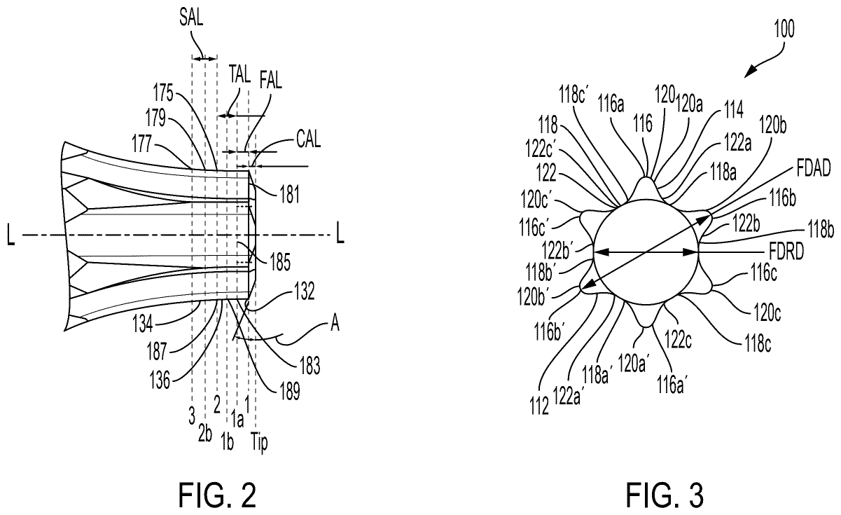

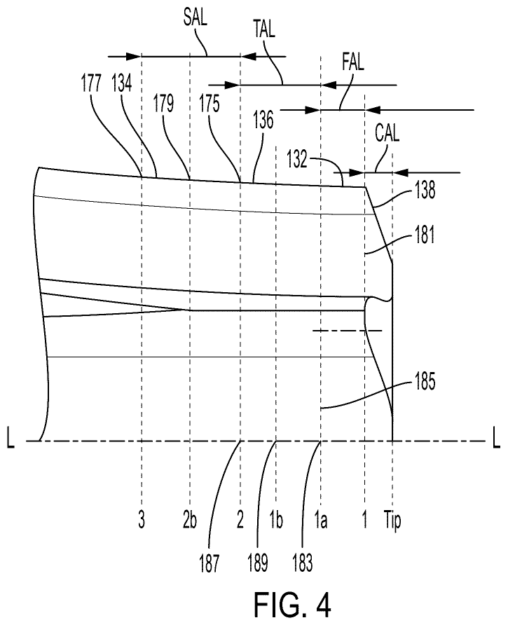

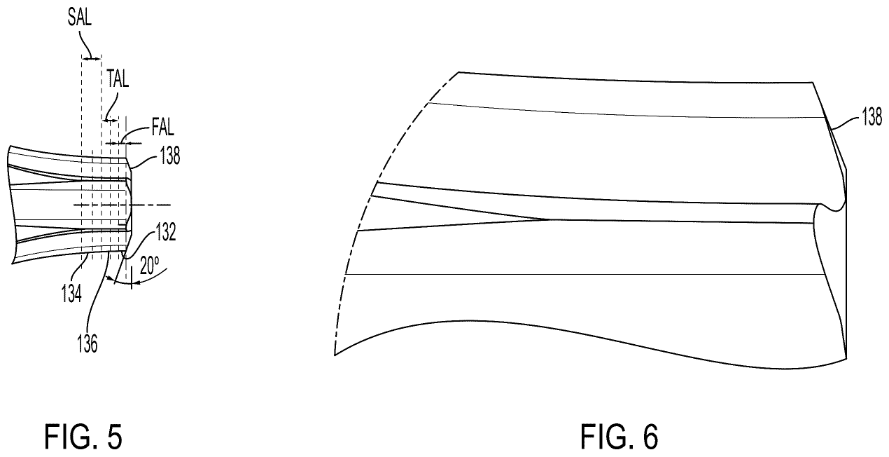

The front portion 132 of the hexalobular shaped head 114 has a first axial length FAL. The protrusions 116 and the recesses 118 in the front portion 132 extend along the first axial length FAL substantially parallel to the longitudinal axis L-L, such that at least one of the apex diameter FDAD or the root diameter FDRD remain substantially constant along the first axial length FAL of the front portion 132. The first portion 132 may be interchangeably referred to as straight portion. Referring to FIGS. 2 and 4, the front portion 132 of the hexalobular shaped head 114 extends between a cross-sectional plane 1 and a cross-sectional plane 1a, the cross-sectional plane 1 and 1a are perpendicular to the longitudinal axis L-L.

In one embodiment, both the apex diameter FDAD and the root diameter FDRD in the front portion 132 remain substantially constant along the first axial length FAL of the front portion 132. In another embodiment, one of the apex diameter FDAD and the root diameter FDRD in the front portion 132 remains substantially constant along the first axial length FAL of the front portion 132, while the other of the apex diameter FDAD and the root diameter FDRD in the front portion 132 may change along the first axial length FAL of the front portion 132 as long as the protrusions 116 and the recesses 118 in the front portion 132 extend along the first axial length FAL substantially parallel to the longitudinal axis L-L.

The rear portion 134 of the hexalobular shaped head 114 has a second axial length SAL. The protrusions 116 and the recesses 118 in the rear portion 134 extend along the second axial length SAL and taper away from the longitudinal axis L-L as the protrusions 116 and the recesses 118 extend longitudinally toward the first end 110. In an embodiment, at least one of the apex diameter FDAD or the root diameter FDRD in the rear portion 134 may increase linearly toward the first end 110 along the second axial length SAL of the rear portion 134 at a rate or an angle. The rear portion 134 may be interchangeably referred to as tapered portion.

In one embodiment, both the apex diameter FDAD and the root diameter FDRD in the rear portion 134 increase linearly toward the first end 110 along the second axial length SAL of the rear portion 134. In another embodiment, one of the apex diameter FDAD and the root diameter FDRD in the rear portion 134 increases linearly toward the first end 110 along the second axial length SAL of the rear portion 134, while the other of the apex diameter FDAD and the root diameter FDRD in the rear portion 134 may remain constant along the second axial length SAL of the rear portion 134 or change non-linearly toward the first end 110 along the second axial length SAL of the rear portion 134 as long as the protrusions 116 and the recesses 118 in the rear portion 134 taper away from the longitudinal axis L-L as the protrusions 116 and the recesses 118 extend longitudinally toward the first end 110. In some embodiments, the angle or rate of increase of the apex diameter and the root diameter toward the first end may be substantially the same; in other embodiments, they may be different. Referring to FIGS. 2 and 4, the rear portion 134 of the hexalobular shaped head 114 extends between a cross-sectional plane 2 and a cross-sectional plane 3, the cross-sectional plane 2 and 3 are perpendicular to the longitudinal axis L-L. For example, the cross-sectional plane 2 is positioned at a front end 175 of the rear portion 134 and the cross-sectional plane 3 is positioned at a rear end 177 of the rear portion 134.

The curved intermediate portion 136 of the hexalobular shaped head 114 is disposed between the front portion 132 and the rear portion 134. The intermediate portion 136 has a third axial length TAL. The protrusions 116 and the recesses 118 in the intermediate portion 136 curve away from the longitudinal axis L-L from the front portion 132 to the rear portion 134 in a concave manner, such that at least one of the apex diameter FDAD or the root diameter FDRD in the intermediate portion 136 increases non-linearly along the third axial length TAL of the intermediate portion 136. The intermediate portion 136 may be interchangeably referred to as radius portion, transition portion, or radius transition portion. Referring to FIGS. 2 and 4, the intermediate portion 136 of the hexalobular shaped head 114 extends between a cross-sectional plane 1a and a cross-sectional plane 2, the cross-sectional plane 1a and 2 are perpendicular to the longitudinal axis L-L. For the curved section 136, the radius of curvature may be in the range between 12 and 18 millimeters.

The fastener driver 100 includes a chamfered front-most end surface 138 between the front portion 132 of the hexalobular shaped head 114 and the second end 112 of the body 108. The chamfered front-most end surface 138 may be interchangeably referred to as chamfered portion. Referring to FIGS. 2 and 4, the rear portion 134 of the hexalobular shaped head 114 extends between a cross-sectional plane tip and a cross-sectional plane 1, the cross-sectional plane tip and 1 are perpendicular to the longitudinal axis L-L. The angle of chamber of the chamfered front-most end surface 138 is shown as angle A in FIG. 2. In one embodiment, the angle of chamfer of the chamfered front-most end surface 138 may be less than approximately 20 degrees. In another embodiment, the angle of chamber of the chamfered front-most end surface 138 may be in the range between approximately 10 and approximately 20 degrees. In yet another embodiment, the angle of chamfer of the chamfered front-most end surface 138 may be in the range between and approximately 20 degrees and its predetermined negative tolerance and approximately 20 degrees and its predetermined positive tolerance. In one embodiment, the chamfer starts at the root outer diameter at the very/most front end.

The chamfered front-most end surface 138, the front portion 132, the intermediate portion 136, and the rear portion 134 are disposed adjacent to each other in that order along the longitudinal axis L-L of the body 108 (i.e., moving from the second end 112 to the first end 110 of the body 108).

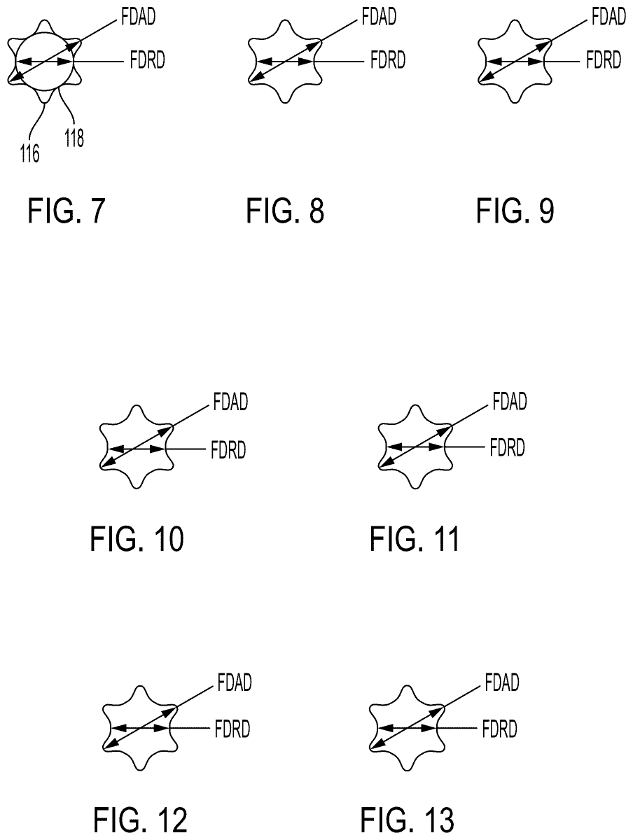

FIGS. 7-13 show various cross-sectional views of the hexalobular shaped head 114 of the fastener driver 100, when the fastener driver 100 is configured to drive a star fastener.

FIG. 7 shows a cross-sectional view of the hexalobular shaped head 114 of the fastener driver 100, where the cross-sectional view is taken at a cross-sectional plane in a tip region or near a front most end surface of the hexalobular shaped head of the fastener driver 100.

FIG. 8 shows a cross-sectional view of the hexalobular shaped head 114 of the fastener driver 100, where the cross-sectional view is taken along a cross-sectional plane “1” at a front end 181 of the front portion 132 of the hexalobular shaped head 114 of the fastener driver 100. FIG. 9 shows a cross-sectional view of the hexalobular shaped head 114 of the fastener driver 100, where the cross-sectional view is taken along a cross-sectional plane “1a” at a rear end 183 of the front portion 132 of the hexalobular shaped head 114 of the fastener driver 100 or at a front end 185 of the curved intermediate portion 136 of the hexalobular shaped head 114 of the fastener driver 100.

Comparing the cross-sectional views in FIGS. 8 and 9, both the apex diameter FDAD and the root diameter FDRD in the front portion 132 remain substantially constant along the first axial length FAL of the front portion 132. For example, when the fastener driver 100 is configured to drive a size T25 fastener, as shown in FIGS. 8 and 9, the apex diameter FDAD and the root diameter FDRD in the front portion 132 remain constant at approximately 4.42 mm and at approximately 3.06 mm, respectively, along the first axial length FAL of the front portion 132.

FIG. 10 shows a cross-sectional view of the hexalobular shaped head 114 of the fastener driver 100, where the cross-sectional view is taken along a cross-sectional plane “1b” that is disposed somewhere (e.g., an intermediate portion 189) in between the front end 185 and a rear end 187 of the intermediate portion 136 of the hexalobular shaped head 114 of the fastener driver 100. FIG. 11 shows a cross-sectional view of the hexalobular shaped head 114 of the fastener driver 100, where the cross-sectional view is taken along a cross-sectional plane “2” at the rear end 187 of the intermediate portion 136 of the hexalobular shaped head 114 of the fastener driver 100 or at the front end 175 of the rear portion 134 of the hexalobular shaped head 114 of the fastener driver 100.

Comparing the cross-sectional views in FIGS. 9, 10 and 11, both the apex diameter FDAD and the root diameter FDRD in the intermediate portion 136 increase non-linearly along the third axial length TAL of the intermediate portion 136. For example, when the fastener driver 100 is configured to drive a size T25 fastener, as shown in FIGS. 9, 10 and 11, the apex diameter FDAD in the intermediate portion 136 increases non-linearly along the third axial length TAL of the intermediate portion 136 from approximately 4.42 mm to approximately 4.43 mm to approximately 4.46 mm, while the root diameter FDRD in the intermediate portion 136 increases non-linearly along the third axial length TAL of the intermediate portion 136 from approximately 3.06 mm to approximately 3.07 mm to approximately 3.11 mm.

FIG. 12 shows a cross-sectional view of the hexalobular shaped head 114 of the fastener driver 100, where the cross-sectional view is taken along a cross-sectional plane “2b” that is disposed somewhere (e.g., an intermediate portion 179) in between the front end 175 and the rear end 177 of the rear portion 134 of the hexalobular shaped head 114 of the fastener driver 100. FIG. 13 shows a cross-sectional view of the hexalobular shaped head 114 of the fastener driver 100, where the cross-sectional view is taken along a cross-sectional plane “3” at the rear end of the rear portion 134 of the hexalobular shaped head 114 of the fastener driver 100.

Comparing the cross-sectional views in FIGS. 11, 12 and 13, both the apex diameter FDAD and the root diameter FDRD in the rear portion 134 increase linearly toward the first end 110 along the second axial length SAL of the rear portion 134. For example, when the fastener driver 100 is configured to drive a size T25 fastener, as shown in FIGS. 11, 12 and 13, the apex diameter FDAD in the rear portion 134 increases linearly toward the first end 110 along the second axial length SAL of the rear portion 134 from approximately 4.46 mm to approximately 4.50 mm to approximately 4.54 mm, while the root diameter FDRD in the rear portion 134 increases linearly toward the first end 110 along the second axial length SAL of the rear portion 134 from approximately 3.11 mm to approximately 3.15 mm to approximately 3.20 mm.

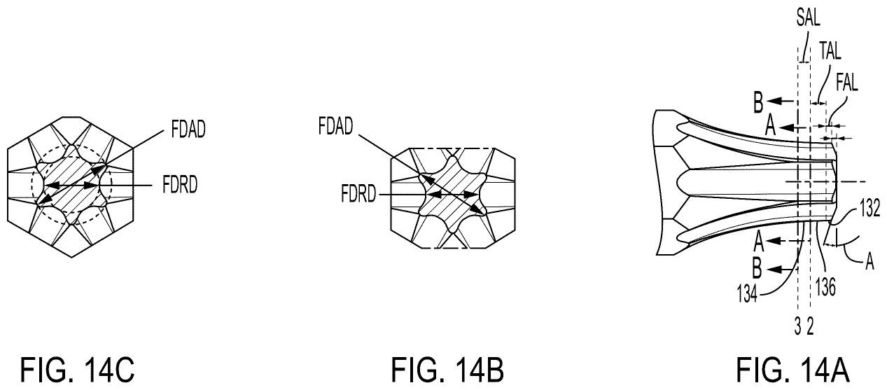

FIGS. 14a-14c show a side view and two cross-sectional views of the hexalobular shaped head 114 of the fastener driver 100, where the head 114 is configured to drive a size T20 fastener, where FIG. 14b shows the cross-sectional view of the hexalobular shaped head of the fastener driver that is taken along axis A-A (i.e., after the intermediate portion 136) in FIG. 14a, and where FIG. 14c shows the cross-sectional view of the hexalobular shaped head 114 of the fastener driver 100 that is taken along axis B-B (i.e., after the rear portion 134) in FIG. 14a.

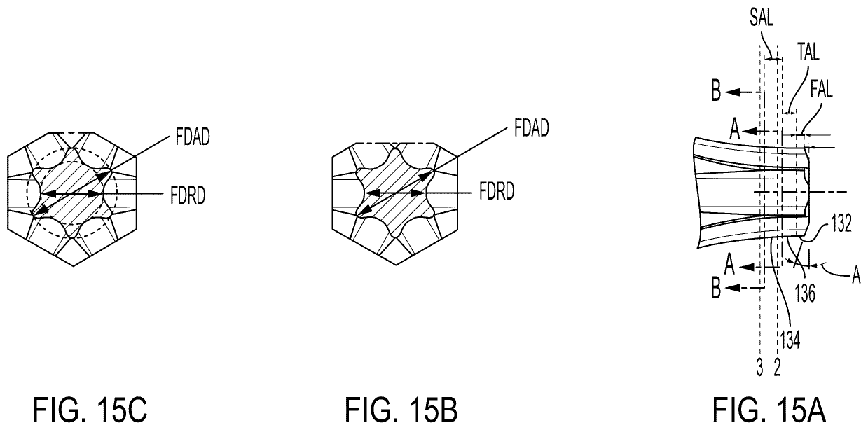

FIGS. 15a-15c show a side view and two cross-sectional views of the hexalobular shaped head 114 of the fastener driver 100, where the head 114 is configured to drive a size T25 fastener, where FIG. 15b shows the cross-sectional view of the hexalobular shaped head 114 of the fastener driver 100 that is taken along axis A-A (i.e., after the intermediate portion 136) in FIG. 15a, and where FIG. 15c shows the cross-sectional view of the hexalobular shaped head 114 of the fastener driver 100 that is taken along axis B-B (i.e., after the rear portion 134) in FIG. 15a.

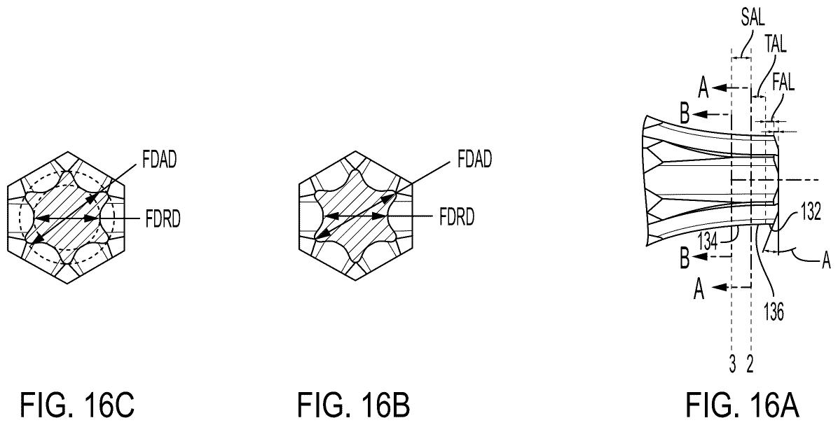

FIGS. 16a-16c show a side view and two cross-sectional views of the hexalobular shaped head 114 of the fastener driver 100, where the head 114 is configured to drive a size T27 fastener, where FIG. 16b shows the cross-sectional view of the hexalobular shaped head 114 of the fastener driver 100 that is taken along axis A-A (i.e., after the intermediate portion 136) in FIG. 16a, and where FIG. 16c shows the cross-sectional view of the hexalobular shaped head 114 of the fastener driver 100 that is taken along axis B-B (i.e., after the rear portion 134) in FIG. 16a.

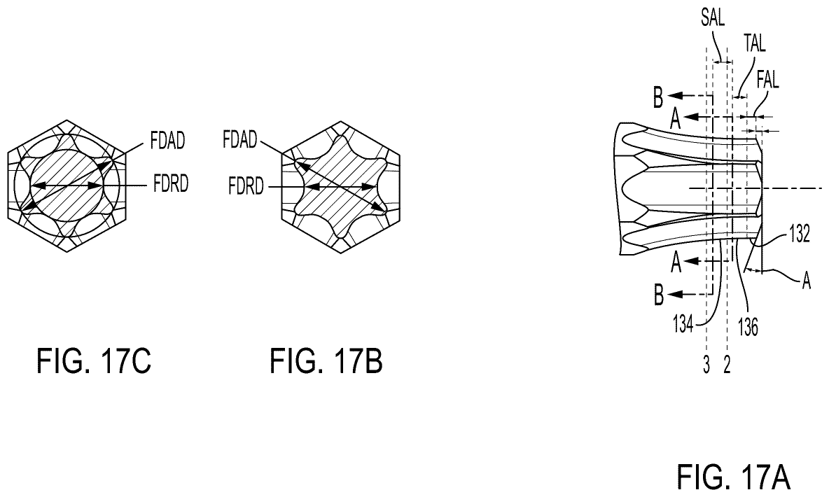

FIGS. 17a-17c show a side view and two cross-sectional views of the hexalobular shaped head 114 of the fastener driver 100, where the head 114 is configured to drive a size T30 fastener, where FIG. 17b shows the cross-sectional view of the hexalobular shaped head 114 of the fastener driver 100 that is taken along axis A-A (i.e., after the intermediate portion 136) in FIG. 17a, and where FIG. 17c shows the cross-sectional view of the hexalobular shaped head 114 of the fastener driver 100 that is taken along axis B-B (i.e., after the rear portion 134) in FIG. 17a.

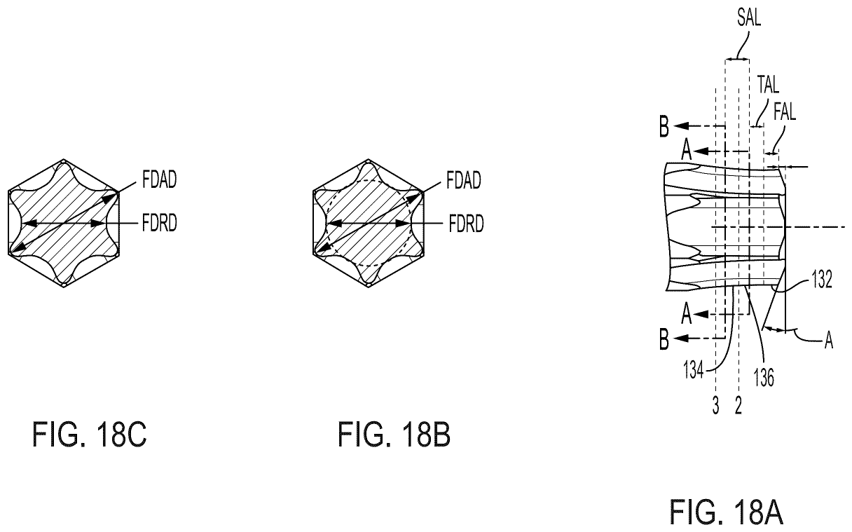

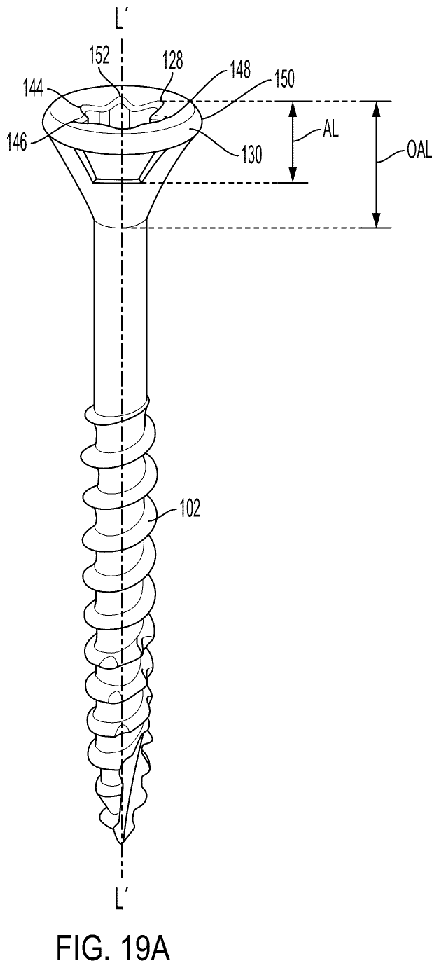

FIGS. 18a-18c show a side view and two cross-sectional views of the hexalobular shaped head 114 of the fastener driver 100, where the head 114 is configured to drive a size T40 fastener, where FIG. 18b shows the cross-sectional view of the hexalobular shaped head 114 of the fastener driver 100 that is taken along axis A-A (i.e., after the intermediate portion 136) in FIG. 18a, and where FIG. 18c shows the cross-sectional view of the hexalobular shaped head 114 of the fastener driver 100 that is taken along axis B-B (i.e., after the rear portion 134) in FIG. 18a.

As shown in FIGS. 19A-19C, the hexalobular opening 128 in the top 130 of the fastener 102 includes alternating protrusions 144 and recesses 146. The protrusions 144 each has an apex. The recesses 146 each has a root. The hexalobular shaped head 114 is receivable in the hexalobular opening 128 in the top 130 of the fastener 102 with the protrusions 116 of the hexalobular shaped head 114 engaging the recesses 146 of the hexalobular opening 128 and the recesses 118 of the hexalobular shaped head 114 engaging the protrusions 144 of the hexalobular opening 128.

The protrusions 144 of the hexalobular shaped opening 128 comprise three opposing pairs of such protrusions, with each pair having an outer diameter that is defined by a distance from the apex of one of the protrusions 144 to the apex of the opposing one of the protrusions 144. Such distance is measured in a plane perpendicular to a fastener axis L′-L′.

The recesses 146 of the hexalobular shaped opening 128 comprise three opposing pairs of such recesses, with each pair having an inner diameter that is defined by a distance from the root of one of the recesses 146 to the root of the opposing one of the recesses 146. Such distance is measured in a plane perpendicular to the fastener axis L′-L′.

The positioning of the protrusions, apexes, recesses, and roots of the fastener driver 100 have been described in detail above. The positioning of the protrusions, apexes, recesses, and roots of the fastener 102 are similar and complementary to the positioning of the protrusions, apexes, recesses, and roots of the fastener driver 100 and will not be described in detail here.

The hexalobular shaped opening 128 has a top end 148 at an outer surface 150 of the fastener 102 and a bottom end 152 inside the fastener top. The protrusions 144 and recesses 146 of the fastener 102 extend along an axial length AL and taper inward toward the fastener axis L′-L′ as they extend from the top end 148 toward the bottom end 152. The opening 128 has an opening axial length OAL from the top end 148 to the bottom end 152.

Tables 1-4 show various dimensions of the head 114 of the fastener driver 100.

For example, Table 1 below shows ranges of approximate axial lengths of portions of the heads 114 of fastener drivers 100, including the axial length (CAL) of the chamfered front-most end surface 138, the first axial length (FAL) of the front portion 132, the second axial length (SAL) of the rear portion 134, and the third axial length (TAL) of the curved intermediate portion 136. The ranges of approximate axial lengths are shown in millimeters. The approximate axial lengths are shown for exemplary fastener drivers 100 that are configured to drive different sized fasteners, including a size T20 fastener, a size T25 fastener, a size T27 fastener, a size T30 fastener, and a size T40 fastener.

TABLE 1
shows the axial lengths of various portions
of the heads of the fastener drivers

| | Range of the | Range of | Range of | Range of |
|---|---|---|---|---|
| | axial length | first axial | second axial | third axial |
| | (in mm) of | length (in | length (in | length of |
| Size | Chamfered | mm) of the | mm) of the | the curved |
| of the | front-most end | front portion, | rear portion, | intermediate |
| fastener | surface, CAL | FAL | SAL | portion, TAL |
| T20 | 0.19-0.23 | 0.26-0.32 | 0.54-0.66 | 0.74-0.90 |
| T25 | 0.23-0.28 | 0.32-0.39 | 0.81-0.99 | 0.74-0.90 |
| T27 | 0.24-0.30 | 0.39-0.47 | 0.90-1.10 | 0.73-0.89 |
| T30 | 0.28-0.34 | 0.44-0.54 | 0.99-1.21 | 0.74-0.90 |
| T40 | 0.33-0.41 | 0.75-0.91 | 1.26-1.54 | 0.74-0.90 |

Tables 2-4 below show ranges of approximate apex diameters and the root diameters of the head 114 of exemplary fastener drivers 100 that are configured to drive size T20, size T25, size T27, size T30, and size T40 fasteners. The apex diameters and the root diameters are shown in millimeters. The apex diameters and the root diameters are shown for the fastener drivers 100 that are configured to drive different sized fasteners, including a size T20 fastener, a size T25 fastener, a size T27 fastener, a size T30 fastener, and a size T40 fastener.

For example, Table 2 below shows approximate apex diameters and root diameters of the head 114 of exemplary fastener drivers 100 measured/taken at the cross-sectional plane “1” and the cross-sectional plane “1a”. The cross-sectional plane “1” and the cross-sectional plane “la” are shown in FIGS. 2 and 4. The cross-sectional plane “1” refers to a plane at the start of the front portion 132 and the cross-sectional plane “1a” refers to a plane at the end of the front portion 132.

As shown in Table 2 below, the approximate apex diameters and the root diameters of the head 114 of the fastener driver 100 measured/taken at the cross-sectional plane “1” and the cross-sectional plane “1a”, that is in the front portion 132 of the head 114 of the fastener drive 100, remain substantially constant along with first axial length FAL of the front portion 132. Cross-section 1 also corresponds to the location where the head 114 of the deepest point in which the fastener driver engages the bottom end portion of the opening in the head of a star fastener when the head 114 is fully inserted into the opening of the head of a star fastener.

TABLE 2
shows the apex diameters and the root diameters of the
fastener driver in the front portion of the head

| | Range of apex diameter (in | Range of root diameter (in |
|---|---|---|
| Size | millimeters) of the fastener | millimeters) of the fastener |
| of the | driver taken at cross- | driver taken at cross- |
| fastener | sectional planes 1 and 1a | sectional planes 1 and 1a |
| T20 | 3.48-4.26 | 2.43-2.97 |
| T25 | 3.98-4.86 | 2.74-3.34 |
| T27 | 4.54-5.54 | 3.18-3.88 |
| T30 | 4.97-6.08 | 3.46-4.22 |
| T40 | 5.97-7.29 | 4.16-5.08 |

Table 3 below shows the approximate apex diameters and root diameters of the head 114 of the fastener driver 100 measured/taken at the cross-sectional plane “2”. The cross-sectional plane “2” is shown in FIGS. 2 and 4. The cross-sectional plane “2” refers to a plane at the start of the rear portion 134.

TABLE 3
shows the apex diameters and the root diameters of the fastener
driver at the start of the rear portion of the head

| | Range of apex diameter (in | Range of root diameter (in |
|---|---|---|
| Size | millimeters) of the fastener | millimeters) of the fastener |
| of the | driver taken at cross- | driver taken at cross- |
| fastener | sectional plane 2 | sectional plane 2 |
| T20 | 3.52-4.30 | 2.48-3.03 |
| T25 | 4.01-4.91 | 2.80-3.42 |
| T27 | 4.57-5.59 | 3.22-3.94 |
| T30 | 5.00-6.12 | 3.50-4.28 |
| T40 | 6.00-7.33 | 4.20-5.14 |

Table 4 below shows the apex diameters and the root diameters of the head 114 of the fastener driver 100 measured/taken at the cross-sectional plane “3”. The cross-sectional plane “3” is shown in FIGS. 2 and 4. The cross-sectional plane “3” refers to a plane approximately at the end of the rear portion 134 and also corresponds to the location where the head 114 of the fastener driver engages the top end of the opening in the head of a star fastener when the head 114 is fully inserted into the opening of the head of a star fastener. In one embodiment, the cross-sectional plane “3” may be at the rear end of the tapered portion. The cross-section where the tapered portion hits the top of the screw head when the bit is inserted (i.e., the location of the bit that hits the top of the screw head) is in this general area but it would be hard to prove that the exact location of cross section plane “3” is (e.g., with respect to the cross-section where the tapered portion hits the top of the screw head when the bit is inserted) as it may vary from screw to screw.

TABLE 4
shows the apex diameters and the root diameters of the fastener
driver at the end of the rear portion of the head

| | Range of apex diameter (in | Range of root diameter (in |
|---|---|---|
| Size | millimeters) of the fastener | millimeters) of the fastener |
| of the | driver taken at cross- | driver taken at cross- |
| fastener | sectional plane 3 | sectional plane 3 |
| T20 | 3.57-4.37 | 2.53-3.09 |
| T25 | 4.09-4.99 | 2.88-3.52 |
| T27 | 4.66-5.70 | 3.33-4.07 |
| T30 | 5.09-6.22 | 3.60-4.40 |
| T40 | 6.12-7.48 | 4.33-5.29 |

As shown in Table 3 and 4, the apex diameters and the root diameters of the head 114 of the fastener driver 100 increase linearly (towards the first end 110) along the second axial length SAL of the rear portion 134 (i.e., from at the cross-sectional plane “2” (i.e., start of the rear portion 134) to at the cross-sectional plane “3” (i.e., end of the rear portion 134)).

When the head 114 is configured to drive a size T20 fastener, the first axial length FAL, the second axial length SAL, and the third axial length TAL may be approximately 0.29 mm, approximately 0.60 mm, and approximately 0.82 mm, respectively. When the head 114 is configured to drive the size T20 fastener, the apex diameter FDAD and the root diameter FDRD in the front portion 132 may be approximately 3.87 mm and approximately 2.70 mm, respectively, the apex diameter FDAD and the root diameter FDRD at the front end 175 of the rear portion 134 may be approximately 3.91 mm and approximately 2.75 mm, respectively, and the apex diameter FDAD and the root diameter FDRD at the rear end 177 of the rear portion 134 may be approximately 3.97 mm and approximately 2.81 mm, respectively. When the head 114 is configured to drive the size T20 fastener, an axial length CAL of the chamfered front-most end surface 138 may be 0.21 mm.

When the head 114 is configured to drive a size T25 fastener, the first axial length FAL, the second axial length SAL, and the third axial length TAL may be approximately 0.35 mm, approximately 0.90 mm and approximately 0.82 mm, respectively.

When the head 114 is configured to drive a size T25 fastener, the apex diameter FDAD and the root diameter FDRD in the front portion 132 may be approximately 4.42 mm and approximately 3.04 mm, respectively, the apex diameter FDAD and the root diameter FDRD at the front end 175 of the rear portion 134 may be approximately 4.46 mm and approximately 3.11 mm, respectively, and the apex diameter FDAD and the root diameter FDRD at the rear end 177 of the rear portion 134 may be approximately 4.54 mm and approximately 3.20 mm, respectively.

When the head 114 is configured to drive a size T25 fastener, an axial length CAL of the chamfered front-most end surface 138 may be 0.25 mm.

When the head 114 is configured to drive a size T27 fastener, the first axial length FAL, the second axial length SAL, and the third axial length TAL may be approximately 0.43 mm, approximately 1.00 mm and approximately 0.81 mm, respectively.

When the head 114 is configured to drive a size T27 fastener, the apex diameter FDAD and the root diameter FDRD in the front portion 132 may be approximately 5.04 mm and approximately 3.53 mm, respectively, the apex diameter FDAD and the root diameter FDRD at the front end 175 of the rear portion 134 may be approximately 5.08 mm and approximately 3.58 mm, respectively, and the apex diameter FDAD and the root diameter FDRD at the rear end 177 of the rear portion 134 may be approximately 5.18 mm and approximately 3.70 mm, respectively.

When the head 114 is configured to drive a size T27 fastener, an axial length CAL of the chamfered front-most end surface 138 may be approximately 0.27 mm.

When the head 114 is configured to drive a size T30 fastener, the first axial length FAL, the second axial length SAL, and the third axial length TAL may be approximately 0.49 mm, approximately 1.10 mm and approximately 0.82 mm, respectively.

When the head 114 is configured to drive the size T30 fastener, the apex diameter FDAD and the root diameter FDRD in the front portion 132 may be approximately 5.52 mm and approximately 3.84 mm, respectively, the apex diameter FDAD and the root diameter FDRD at the front end 175 of the rear portion 134 may be approximately 5.56 mm and approximately 3.89 mm, respectively, and the apex diameter FDAD and the root diameter FDRD at the rear end 177 of the rear portion 134 may be approximately 5.66 mm and approximately 4.00 mm, respectively.

When the head 114 is configured to drive the size T30 fastener, an axial length CAL of the chamfered front-most end surface 138 may be approximately 0.31 mm.

When the head 114 is configured to drive a size T40 fastener, the first axial length FAL, the second axial length SAL, and the third axial length TAL may be approximately 0.83 mm, approximately 1.40 mm and approximately 0.82 mm, respectively.

When the head 114 is configured to drive the size T40 fastener, the apex diameter FDAD and the root diameter FDRD in the front portion 132 may be approximately 6.63 mm and approximately 4.62 mm, respectively, the apex diameter FDAD and the root diameter at the front end 175 of the rear portion 134 may be approximately 6.67 mm and approximately 4.67 mm, respectively, and the apex diameter FDAD and the root diameter at the rear end 177 of the rear portion 134 may be approximately 6.80 mm and approximately 4.81 mm, respectively. When the head 114 is configured to drive the size T40 fastener, an axial length CAL of the chamfered front-most end surface 138 may be approximately 0.37 mm.

Table 5 shows various dimensions of the fastener 102. For example, Table 5 below shows the apex diameters and the root diameters of the fastener 102 measured/taken top and bottom (i.e., top of the opening 128 of the fastener 102 and the bottom of the opening 128 of the fastener 102). The apex diameters and the root diameters are shown in millimeters. The apex diameters and the root diameters are shown for different sized fasteners, including a size T20 fastener, a size T25 fastener, a size T27 fastener, a size T30 fastener, and a size T40 fastener.

TABLE 5
shows the apex diameters and the root diameters of the fastener
at the top of the opening and at the bottom of the opening

| | Apex | Root | Apex | Root |
|---|---|---|---|---|
| | diameter (in | diameter (in | diameter (in | diameter (in |
| | millimeters) | millimeters) | millimeters) | millimeters) |
| | of the | of the | of the | of the |
| | fastener | fastener | fastener | fastener |
| Size | taken at | taken at | taken at | taken at |
| of the | top of | top of | bottom of | bottom of |
| fastener | the opening | the opening | the opening | the opening |
| T20 | 3.96 | 2.90 | 3.86 | 2.82 |
| T25 | 4.62 | 3.40 | 4.42 | 3.3 |
| T27 | 5.3 | 3.82 | 5.3 | 3.68 |
| T30 | 5.6 | 4.08 | 5.38 | 3.98 |
| T40 | 6.8 | 5.06 | 6.62 | 4.8 |

Table 6 shows various ratios of the dimensions (e.g., the apex diameters and the root diameters) of the fastener driver 100 and the fastener 102. The apex diameters and the root diameters that are referred to in this Table are expressed in millimeters. The ratios are shown for the fastener drivers 100 that are configured to drive different sized fasteners, including a size T20 fastener, a size T25 fastener, a size T27 fastener, a size T30 fastener, and a size T40 fastener.

The second column of Table 6 shows ratios of the apex diameter of the fastener driver 100 taken at the cross-sectional plane 3 (as shown in FIGS. 2 and 4) to the apex diameter of the fastener taken at the top of the opening 128. The apex diameter of the fastener driver 100 taken at the cross-sectional plane 3 is shown in the second column of the Table 4. The apex diameter of the fastener 102 taken at the top of the opening 128 is shown in the second column of the Table 5. A ratio of the apex diameter of the hexalobular shaped head 114, at a cross-sectional plane in the rear portion 134 at a location that corresponds to the top end 148 of the fastener 102 when the hexalobular shaped head 114 is fully inserted into the hexalobular opening 128 of the fastener 102, to an apex diameter of the fastener 102, at a cross-sectional plane at the top end 148 of the fastener 102, is between approximately 0.98 and approximately 1.01.

The third column of Table 6 shows ratios of the root diameter of the fastener driver 100 taken at the cross-sectional plane 3 (as shown in FIGS. 2 and 4) to the root diameter of the fastener 102 taken at the top of the opening 128. The root diameter of the fastener driver 100 taken at the cross-sectional plane 3 is shown in the third column of the Table 4. The root diameter of the fastener 102 taken at the top of the opening 128 is shown in the third column of the Table 5. A ratio of the root diameter of the hexalobular shaped head 114, at the cross-sectional plane in the rear portion 134 at the location that corresponds to the top end 148 of the fastener 102 when the hexalobular shaped head 114 is fully inserted into the hexalobular opening 128 of the fastener 102, to a root diameter of the fastener 102, at the cross-sectional plane at the top end 148 of the fastener 102, is between approximately 0.94 and approximately 0.98.

The fourth column of Table 6 shows ratios of the apex diameter of the fastener driver 100 taken at the cross-sectional plane 1 or 1a (as shown in FIGS. 2 and 4) to the apex diameter of the fastener 102 taken at the bottom of the opening 128. The apex diameter of the fastener driver 100 taken at the cross-sectional plane 1 or 1a is shown in the second column of the Table 2. The apex diameter of the fastener 102 taken at the bottom of the opening 128 is shown in the fourth column of the Table 5. A ratio of the apex diameter of the hexalobular shaped head 114, at a cross-sectional plane in the front portion 132 at a location that corresponds to the bottom end 152 of the fastener top (or the bottom end of the opening) when the hexalobular shaped head 114 is fully inserted into the hexalobular opening 128 of the fastener 102, to an apex diameter of the fastener 102, at a cross-sectional plane at the bottom end 152 of the fastener top, is between approximately 0.95 and approximately 1.03.

The fifth column of Table 6 shows ratios of the root diameter of the fastener driver 100 taken at the cross-sectional plane 1 or 1a (as shown in FIGS. 2 and 4) to the root diameter of the fastener 102 taken at the bottom of the opening 128. The root diameter of the fastener driver 100 taken at the cross-sectional plane 1 or 1a is shown in the third column of the Table 2. The root diameter of the fastener 102 taken at the bottom of the opening 128 is shown in the fifth column of the Table 5. A ratio of the root diameter of the hexalobular shaped head 114, at a cross-sectional plane in the front portion 132 at a location that corresponds to the bottom end 152 of the fastener top when the hexalobular shaped head 114 is fully inserted into the hexalobular opening 128 of the fastener 102, to a root diameter of the fastener 102, at a cross-sectional plane at the bottom end 152 of the fastener top (or the bottom end of the opening), is between approximately 0.92 and approximately 0.96

TABLE 6
shows various ratios of the dimensions (e.g., the apex diameters
and the root diameters) of the fastener driver and the fastener

| | Ratio of the | Ratio of the | Ratio of the | Ratio of the |
|---|---|---|---|---|
| | apex diameter | root diameter | apex diameter | root diameter |
| | of the | of the | of the | of the |
| | fastener | fastener | fastener | fastener |
| | driver taken | driver taken | driver taken | driver taken |
| | at the cross- | at the cross- | at the cross- | at the cross- |
| | sectional | sectional | sectional | sectional |
| | plane 3 to | plane 3 to | plane 1/1a to | plane 1/1a to |
| | the apex | the root | the apex | the root |
| | diameter of | diameter of | diameter of | diameter of |
| | the fastener | the fastener | the fastener | the fastener |
| Size | taken at the | taken at the | taken at the | taken at the |
| of the | top of the | top of the | bottom of the | bottom of the |
| fastener | opening | opening | opening | opening |
| T20 | 1.00 | 0.97 | 1.00 | 0.96 |
| T25 | 0.98 | 0.94 | 1.00 | 0.92 |
| T27 | 0.98 | 0.97 | 0.95 | 0.96 |
| T30 | 1.01 | 0.98 | 1.03 | 0.96 |
| T40 | 1.00 | 0.95 | 1.00 | 0.96 |

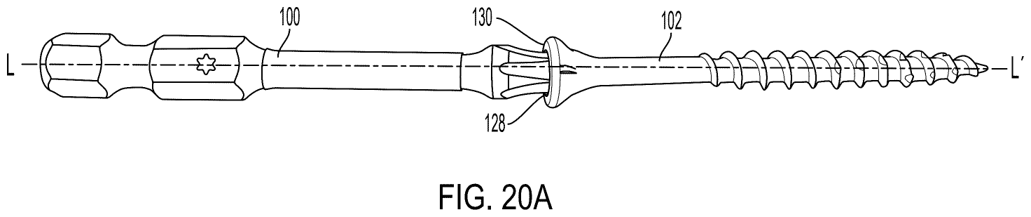

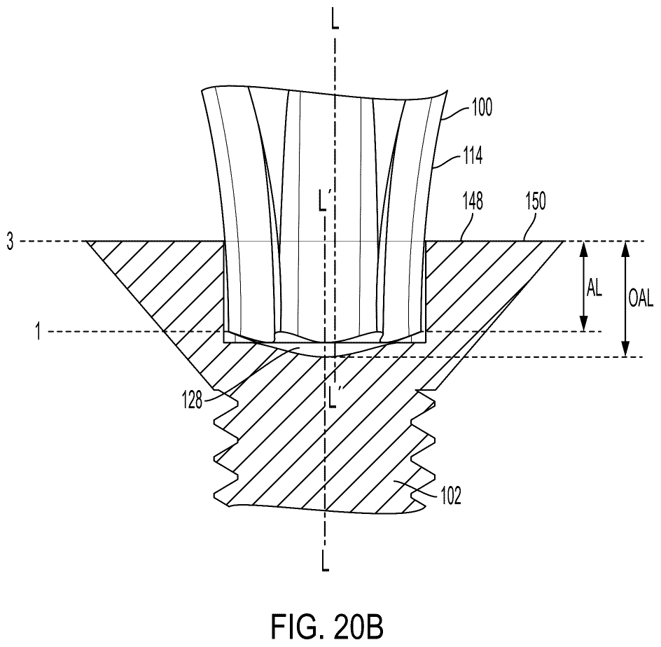

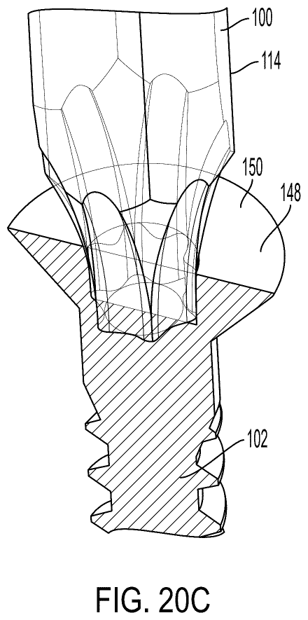

As shown in FIGS. 20A-20C, when the fastener driver 100 is fully inserted into the opening 128 of the hexalobular fastener 102, an angle of wobble of the fastener driver 100 is measured between the longitudinal axis L-L of the fastener driver 100 and a longitudinal axis L′-L′ (as shown in FIGS. 19 and 20) of the hexalobular fastener 102. In one embodiment, the angle of wobble for the fastener driver 100 may be less than approximately 8 degrees. In another embodiment, the angle of wobble for the fastener driver 100 may be less than approximately 7 degrees. In yet another embodiment, the angle of wobble for the fastener driver 100 may be less than approximately 6 degrees.

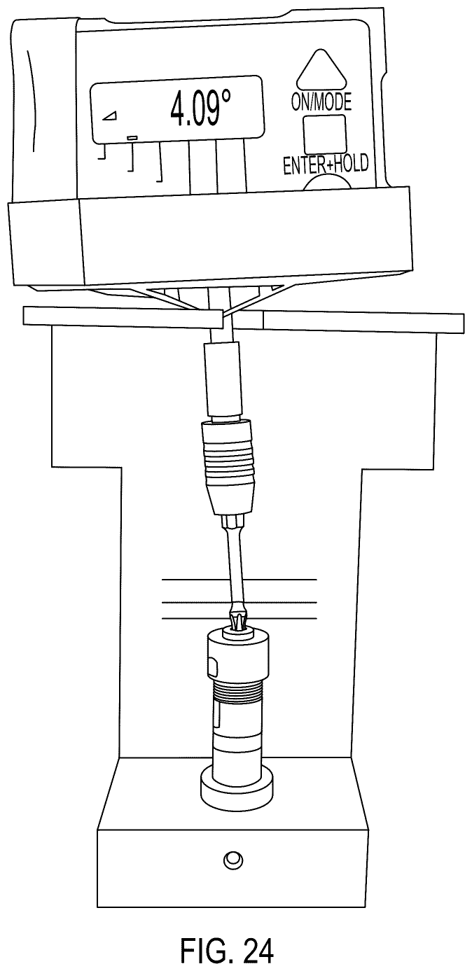

In tests of exemplary embodiments of the fastener drivers disclosed in this patent application, angles of wobble of the fastener drivers 100 were compared to the angles of wobble of prior art fastener drivers when engaged with the heads of star fasteners. An inclinometer test rig was used to measure the angle of wobble of the fastener drivers. A fastener was held securely in a chuck (i.e., at the bottom of fixture). The fastener driver end (i.e., tip) engaged with the fastener in the same manner as when driving the fastener. The driving portion of the fastener driver 100 is attached to an inclinometer using a rigid and tightly fitting shaft. The shaft rides on a track and can only move left to right as shown in FIG. 24. The single degree of freedom is similar to an inverted pendulum where the center of motion (the wobble) is the tip of the fastener driver inside the fastener. Gravity may result in the fastener driver, shaft, and inclinometer to tilt to one side. The inclinometer reading is taken and then manually pushed to the other side and a second reading is taken. The exemplary inclinometer test rig with the fastener driver and the fastener disposed therein for measuring the angle of wobble is shown in FIG. 24.

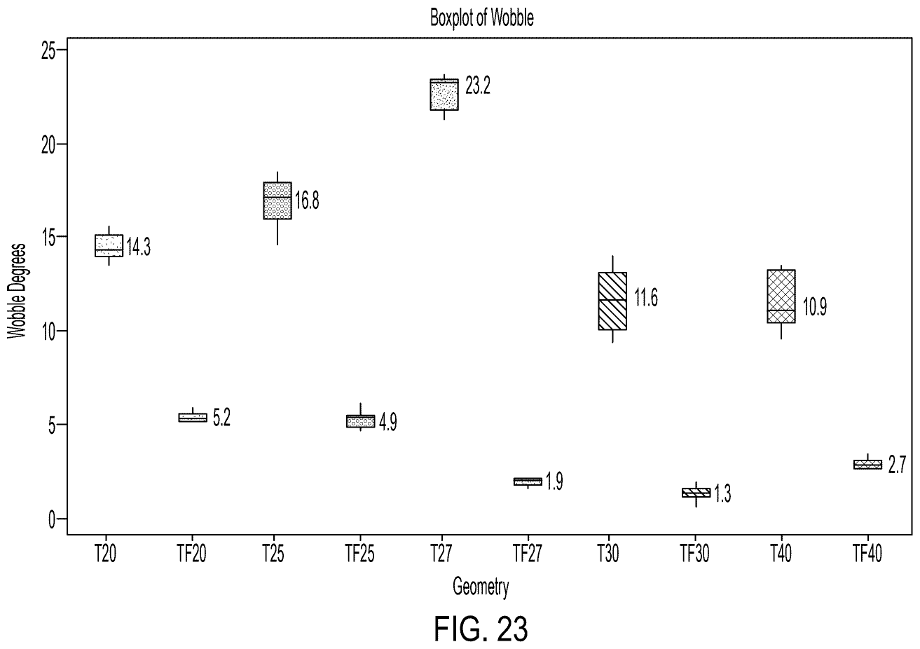

The results of the measurements/tests are plotted in FIG. 23. FIG. 23 shows a graphical representation of a comparison of the angles of wobble for the fastener drivers of the present patent application with the angles of wobble for the prior art fastener drivers, where an angle of wobble is measured between a longitudinal axis of the fastener driver and a longitudinal axis of the fastener when the fastener driver is fully inserted into an opening of the fastener.

The “T20” “T25” “T27” “T30” and “T40” in FIG. 23 refer to the prior art fastener drivers that are configured to drive a size T20 fastener, a size T25 fastener, a size T27 fastener, a size T30 fastener, and a size T40 fastener, respectively. The “TF20” “TF25” “TF27” “TF30” and “TF40” in FIG. 23 refer to the fastener drivers 100 of the present patent application that are configured to drive a size T20 fastener, a size T25 fastener, a size T27 fastener, a size T30 fastener, and a size T40 fastener, respectively. In one embodiment, the label “TF” may refer to tight fit fastener driver 100 of the present patent application.

As can be seen from FIG. 23, the fastener drivers 100 of the present patent application have between 3 to 6 times less wobble than the prior art fastener drivers. The comparison of the angles of wobble for the fastener drivers 100 of the present patent application with the angles of wobble for the prior art fastener drivers are also shown in Table 7 below.

TABLE 7
shows a comparison of angles of wobble for the prior art fastener
drivers and the fastener driver of the present patent application

| | | | Decrease (in percentage) |
|---|---|---|---|
| | | Angle of wobble | in the angle of wobble in |
| | Angle of wobble | (in degrees) for | the fastener driver of the |
| Size | (in degrees) for | fastener driver of | present patent application |
| of the | prior art | the present patent | compared to the prior art |
| fastener | fastener driver | application | fastener drivers |
| T20 | 14.3 | 5.2 | 63.63% |
| T25 | 16.8 | 4.9 | 70.83% |
| T27 | 23.2 | 1.9 | 91.81% |
| T30 | 11.6 | 1.3 | 88.79% |
| T40 | 10.9 | 2.7 | 75.23% |

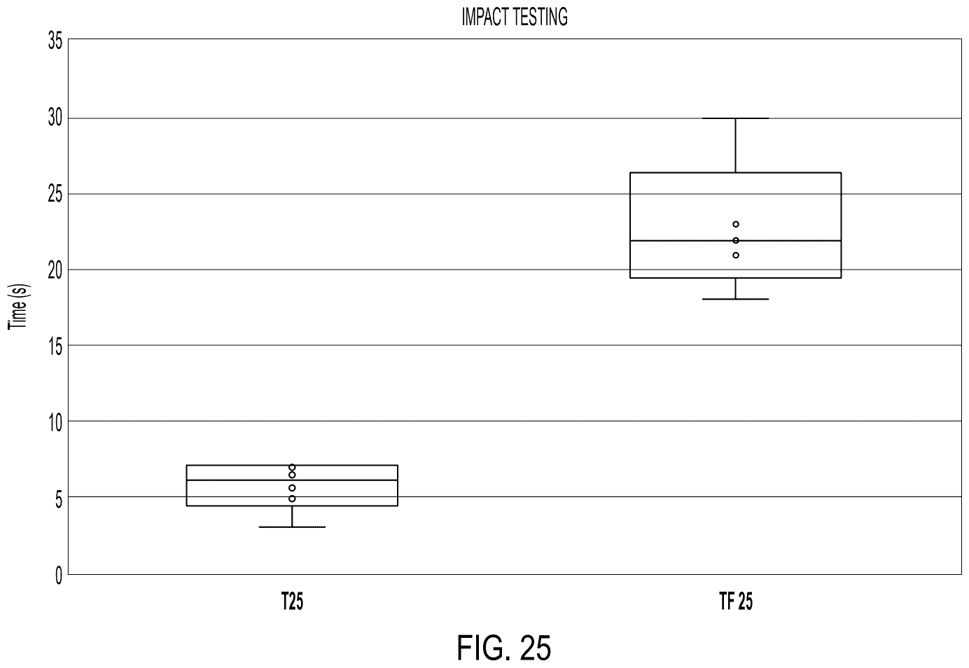

Referring to FIG. 25, the fastener drivers 100 of the present patent application may have greater life than existing fastener drivers. In one life test, bits having existing fastener heads and fastener heads of the present application were inserted into openings in a solid block having the head geometry of a TORX fastener. The bits were then driven in rotation by an impact driver until the fastener driver fractured or broke. The amount of time until the fastener driver fractures or breaks is indicative of the life of the fastener driver, with a longer time corresponding to a longer life. In one example test, an existing DEWALT FlexTorq™ screwdriving bit with a standard TORX T25 head was compared to a fastener driver 100 of the present application, each inserted into a receptacle corresponding to a TORX T25 fastener. As shown in FIG. 25, the existing fastener drivers (indicated by T25) had an average time to breakage of approximately 4 to 7 seconds. The fastener drivers of the present application (indicated by TF25) had an average time to breakage of approximately 20 to 27 seconds. Since all other dimensions of the fastener drivers were the same, this improvement is attributable to the improved geometry of the fastener driver head as disclosed in this patent application. Thus, the fastener drivers of the present application have a life that is at least approximately 4 to 5 times longer than the life of existing fastener drivers.

In one embodiment, dimensions of the fastener driver 100 of the present patent application may be up to 5 percent, 10 percent, 15 percent or 20 percent greater than or up to 5 percent, 10 percent, 15 percent or 20 percent less than the values described throughout the present patent application. In another embodiment, dimensions of the fastener driver 100 of the present patent application may be in the range of +/−5 percent or+/−10 percent of the values described throughout the present patent application.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A fastener driver configured to be rotated to drive a fastener, the fastener driver comprising:
a body including a longitudinal axis, a first end for being rotated by a rotational input, and an opposing second end for engaging with and driving the fastener,
the second end of the body including:
a hexalobular shaped head, the hexalobular shaped head including alternating protrusions and recesses, the protrusions each having an apex and the recesses each having a root,
wherein the protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis,
wherein the recesses comprise three opposing pairs of such recesses, with each pair having a root diameter that is defined by a distance from the root of one of the recesses to the root of the opposing one of the recesses, wherein such distance is measured in a plane perpendicular to the longitudinal axis, the protrusions and recesses of the hexalobular shaped head being configured to engage with corresponding recesses and protrusions of a hexalobular opening in a top of the fastener; and
the hexalobular shaped head further including:
a front portion having a first axial length, wherein the protrusions and recesses extend along the first axial length substantially parallel to the longitudinal axis, such that at least one of the apex diameter or the root diameter remain substantially constant along the first axial length of the front portion;
a rear portion having a second axial length, wherein the protrusions and recesses extend along the second axial length and taper away from the longitudinal axis as they extend longitudinally toward the first end, wherein at least one of the apex diameter or the root diameter increase linearly toward the first end along the second axial length of the rear portion; and
a curved intermediate portion disposed between the front portion and the rear portion having a third axial length, wherein the protrusions and the recesses curve away from the longitudinal axis from the front portion to the rear portion in a concave manner, such that at least one of the apex diameter or the root diameter increase non-linearly along the third axial length of the intermediate portion.

2. The fastener driver of claim 1, further comprising a chamfered front-most end surface between the front portion and the second end of the body.

3. The fastener driver of claim 2, wherein the front portion, the intermediate portion, and the rear portion are disposed adjacent to each other in that order along the longitudinal axis of the body.

4. The fastener driver of claim 1, wherein the hexalobular opening in the top of the fastener comprises alternating protrusions and recesses, the protrusions each having an apex and the recesses each having a root, and wherein the hexalobular shaped head is receivable in the hexalobular opening in the top of the fastener with the protrusions of the hexalobular shaped head engaging the recesses of the hexalobular opening and the recesses of the hexalobular shaped head engaging the protrusions of the hexalobular opening.

5. The fastener driver of claim 4, wherein the protrusions of the hexalobular shaped opening comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis, and wherein the recesses of the hexalobular shaped opening comprise three opposing pairs of such recesses, with each pair having an inner diameter that is defined by a distance from the root of one of the recesses to the root of the opposing one of the recesses, wherein such distance is measured in a plane perpendicular to the fastener axis.

6. The fastener driver of claim 5, wherein the hexalobular shaped opening has a top end at an outer surface of the fastener and a bottom end inside the fastener top, wherein the protrusions and recesses of the fastener extend along an axial length and taper inward toward the fastener axis as they extend from the top end toward the bottom end, and wherein the opening has an opening axial length from the top end to the bottom end.

7. The fastener driver of claim 6, wherein a ratio of the apex diameter of the hexalobular shaped head, at a cross-sectional plane in the rear portion at a location that corresponds to a top end of the fastener when the hexalobular shaped head is fully inserted into the hexalobular opening of the fastener, to an apex diameter of the fastener, at a cross-sectional plane at the top end of the fastener, is between approximately 0.98 and approximately 1.01.

8. The fastener driver of claim 7, wherein a ratio of the root diameter of the hexalobular shaped head, at the cross-sectional plane in the rear portion at the location that corresponds to the top end of the fastener when the hexalobular shaped head is fully inserted into the hexalobular opening, to a root diameter of the fastener, at the cross-sectional plane at the top end of the fastener, is between approximately 0.94 and approximately 0.98.

9. The fastener driver of claim 8, wherein a ratio of the apex diameter of the hexalobular shaped head, at a cross-sectional plane in the front portion at a location that corresponds to the bottom end of the fastener when the hexalobular shaped head is fully inserted into the hexalobular opening of the fastener, to an apex diameter of the fastener, at a cross-sectional plane at the bottom end of the fastener, is between approximately 0.95 and approximately 1.03.

10. The fastener driver of claim 9, wherein a ratio of the root diameter of the hexalobular shaped head, at a cross-sectional plane in the front portion at a location that corresponds to the bottom end of the fastener when the hexalobular shaped head is fully inserted into the hexalobular opening of the fastener, to a root diameter of the fastener, at a cross-sectional plane at the bottom end of the fastener, is between approximately 0.92 and approximately 0.96.

11. The fastener driver of claim 1, wherein the fastener is a hexalobular fastener, and wherein, when the fastener driver is fully inserted into an opening of the hexalobular fastener, an angle of wobble between the longitudinal axis of the fastener driver and a longitudinal axis of the hexalobular fastener is less than approximately 8 degrees.

12. The fastener driver of claim 1, wherein the protrusions are non-spirally formed along the head.

13. The fastener driver of claim 1, wherein the head is configured to drive one of: (1) a size T20 fastener and the first axial length, the second axial length, and the third axial length are approximately 0.29 mm, approximately 0.60 mm, and approximately 0.82 mm, respectively; (2) a size T25 fastener and the first axial length, the second axial length, and the third axial length are approximately 0.35 mm, approximately 0.90 mm and approximately 0.82 mm, respectively; (3) a size T27 fastener and the first axial length, the second axial length, and the third axial length are approximately 0.43 mm, approximately 1.00 mm and approximately 0.81 mm, respectively; (4) a size T30 fastener and the first axial length, the second axial length, and the third axial length are approximately 0.49 mm, approximately 1.10 mm and approximately 0.82 mm, respectively; or (5) a size T40 fastener and the first axial length, the second axial length, and the third axial length are approximately 0.83 mm, approximately 1.40 mm and approximately 0.82 mm, respectively.

14. The fastener driver of claim 1, wherein the head is configured to drive one of: (1) a size T20 fastener and the apex diameter and the root diameter in the front portion are approximately 3.87 mm and approximately 2.70 mm, respectively, the apex diameter and the root diameter at a front end of the rear portion are approximately 3.91 mm and approximately 2.75 mm, respectively, and the apex diameter and the root diameter at a rear end of the rear portion are approximately 3.97 mm and approximately 2.81 mm, respectively; (2) a size T25 fastener and the apex diameter and the root diameter in the front portion are approximately 4.42 mm and approximately 3.04 mm, respectively, the apex diameter and the root diameter at a front end of the rear portion are approximately 4.46 mm and approximately 3.11 mm, respectively, and the apex diameter and the root diameter at a rear end of the rear portion are approximately 4.54 mm and approximately 3.20 mm, respectively; (3) a size T27 fastener, the apex diameter and the root diameter in the front portion are approximately 5.04 mm and approximately 3.53 mm, respectively, the apex diameter and the root diameter at a front end of the rear portion are approximately 5.08 mm and approximately 3.58 mm, respectively, and the apex diameter and the root diameter at a rear end of the rear portion are approximately 5.18 mm and approximately 3.70 mm, respectively; (4) a size T30 fastener and the apex diameter and the root diameter in the front portion are approximately 5.52 mm and approximately 3.84 mm, respectively, the apex diameter and the root diameter at a front end of the rear portion are approximately 5.56 mm and approximately 3.89 mm, respectively, and the apex diameter and the root diameter at a rear end of the rear portion are approximately 5.66 mm and approximately 4.00 mm, respectively; or (5) a size T40 fastener and the apex diameter and the root diameter in the front portion are approximately 6.63 mm and approximately 4.62 mm, respectively, the apex diameter and the root diameter at a front end of the rear portion are approximately 6.67 mm and approximately 4.67 mm, respectively, and the apex diameter and the root diameter at a rear end of the rear portion are approximately 6.80 mm and approximately 4.81 mm, respectively.

15. The fastener driver of claim 1, wherein the head is configured to drive one of: (1) a size T20 fastener and an axial length of the chamfered front-most end surface is approximately 0.21 mm; (2) a size T25 fastener and an axial length of the chamfered front-most end surface is approximately 0.25 mm; (3) a size T27 fastener and an axial length of the chamfered front-most end surface is approximately 0.27 mm; (4) a size T30 fastener and an axial length of the chamfered front-most end surface is approximately 0.31 mm; or (5) a size T40 fastener and an axial length of the chamfered front-most end surface is approximately 0.37 mm.

16. A fastener driver configured to be rotated to drive a fastener, the fastener driver comprising:
a body including a longitudinal axis, a first end for being rotated by a rotational input, and an opposing second end for engaging with and driving the fastener,
the second end of the body including:
a hexalobular shaped head, the hexalobular shaped head including alternating protrusions and recesses, the protrusions each having an apex and the recesses each having a root;
wherein the protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis,
wherein the recesses comprise three opposing pairs of such recesses, with each pair having a root diameter that is defined by a distance from the root of one of the recesses to the root of the opposing one of the recesses, wherein such distance is measured in a plane perpendicular to the longitudinal axis, the protrusions and recesses of the hexalobular shaped head being configured to engage with corresponding recesses and protrusions of a hexalobular opening in a top of the fastener,
the hexalobular shaped head further including:
a front portion having a first axial length, wherein the protrusions and recesses extend along the first axial length substantially parallel to the longitudinal axis, such that at least one of the apex diameter or the root diameter remain substantially constant along the first axial length of the front portion;
a rear portion having a second axial length, wherein the protrusions and recesses extend along the second axial length and taper away from the longitudinal axis as they extend longitudinally toward the first end, wherein at least one of the apex diameter or the root diameter increase linearly toward the first end along the second axial length of the rear portion;
wherein the hexalobular opening in the top of the fastener comprises alternating protrusions and recesses, the protrusions each having an apex and the recesses each having a root, and wherein the hexalobular shaped head is receivable in the hexalobular opening in the top of the fastener with the protrusions of the head engaging the recesses of the opening and the recesses of the head engaging the protrusions of the opening,
wherein the protrusions of the opening comprise three opposing pairs of such protrusions, with each pair having an outer diameter that is defined by a distance from the apex of one of the protrusions to the apex of the opposing one of the protrusions, wherein such distance is measured in a plane perpendicular to a fastener axis, and wherein the recesses of the opening comprise three opposing pairs of such recesses, with each pair having an inner diameter that is defined by a distance from the root of one of the recesses to the root of the opposing one of the recesses, wherein such distance is measured in a plane perpendicular to the fastener axis,
wherein the opening has a top end at an outer surface of the fastener and a bottom end inside the fastener top, wherein the protrusions and recesses of the fastener extend along an axial length and taper inward toward the fastener axis as they extend from the top end toward the bottom end, and wherein the opening has an axial length from the top end to the bottom end, and
wherein a ratio of the apex diameter of the hexalobular shaped head, at a cross-sectional plane in the rear portion at a location that corresponds to the top end of the fastener when the head is fully inserted into the opening, to an apex diameter of the fastener, at cross-sectional plane at the top end of the fastener, is between approximately 0.98 and approximately 1.01.

17. The fastener driver of claim 16, wherein the fastener is a hexalobular fastener, and wherein, when the fastener driver is fully inserted into an opening of the hexalobular fastener, an angle of wobble between the longitudinal axis of the fastener driver and a longitudinal axis of the hexalobular fastener is less than approximately 8 degrees.

18. A fastener driver configured to be rotated to drive a fastener, the fastener driver comprising:
a body including a longitudinal axis, a first end for being rotated by a rotational input, and an opposing second end for engaging with and driving the fastener,
the second end of the body including:
a hexalobular shaped head, the hexalobular shaped head including alternating protrusions and recesses, the protrusions each having an apex and the recesses each having a root;
wherein the protrusions comprise three opposing pairs of such protrusions, with each pair having an apex diameter that is defined by a distance from the apex of one of the protrusions to the apex of the opposing one of the protrusions, wherein such distance is measured in a plane perpendicular to the longitudinal axis,
wherein the recesses comprise three opposing pairs of such recesses, with each pair having a root diameter that is defined by a distance from the root of one of the recesses to the root of the opposing one of the recesses, wherein such distance is measured in a plane perpendicular to the longitudinal axis, the protrusions and recesses of the hexalobular shaped head being configured to engage with corresponding recesses and protrusions of a hexalobular opening in a top of the fastener,
the hexalobular shaped head further including:
a front portion having a first axial length, wherein the protrusions and recesses extend along the first axial length substantially parallel to the longitudinal axis, such that at least one of the apex diameter or the root diameter remain substantially constant along the first axial length of the front portion;
a rear portion having a second axial length, wherein the protrusions and recesses extend along the second axial length and taper away from the longitudinal axis as they extend longitudinally toward the first end, wherein at least one of the apex diameter or the root diameter increase linearly toward the first end along the second axial length of the rear portion;
wherein, when the fastener driver is fully inserted into the hexalobular opening of the fastener, an angle of wobble between the longitudinal axis of the fastener driver and a longitudinal axis of the fastener is less than approximately 8 degrees.

19. The fastener driver of claim 18, wherein the second end of the body comprises a front-most end surface being chamfered to extend away from the longitudinal axis as it extends in an axial direction toward the first end,
wherein the chamfered front-most end surface is between the front portion and the second end of the body,
wherein the hexalobular shaped head further includes a curved intermediate portion disposed between the front portion and the rear portion having a third axial length, and
wherein the protrusions and the recesses curve away from the longitudinal axis from the front portion to the rear portion in a concave manner, such that at least one of the apex diameter or the root diameter increase non-linearly along the third axial length of the intermediate portion.

20. The fastener driver of claim 19, wherein the chamfered front-most end surface, the front portion, the intermediate portion, and the rear portion are disposed adjacent to each other in that order along the longitudinal axis of the body.
